(19) United States
(12) Patent Application Publication
(10) Pub. No.: US 2026/0059453 A1
(43) Pub. Date: Feb. 26, 2026

(54) REDUCING POWER CONSUMPTION AND UPLINK (UL) INTERFERENCE BASED ON FEEDBACK FROM AMBIENT INTERNET OF THINGS (IOT) TAGS

(71) Applicant: QUALCOMM Incorporated, San Diego, CA (US)

(72) Inventors: Varun Amar REDDY, San Diego, CA (US); Sony AKKARAKARAN, Poway, CA (US)

(21) Appl. No.: 18/815,730

(22) Filed: Aug. 26, 2024

(51) Int. Cl. H04W 52/02; H04B 17/318; H04W 72/542

(52) U.S. Cl. CPC H04W 52/0277; H04B 17/318; H04W 72/542

(57) ABSTRACT

Systems and techniques are described for wireless communications. For example, a computing device can receive one or more energizing signals from one or more energizing devices. The computing device can store, in the computing device (e.g., in an energy storage element), energy from the one or more energizing signals. The computing device can determine a quality metric based on the computing device, the one or more energizing signals, and/or the one or more energizing devices. The computing device can transmit, to a network entity via one or more wireless communication devices based on the energy stored in the computing device, a beacon comprising the quality metric for the network entity to determine one or more subsequent energizing signals.

### FIELD

The present disclosure generally relates to wireless communications. For example, aspects of the present disclosure relate to reducing power consumption and uplink (UL) interference based on feedback from ambient internet of things (IOT) tags.

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for wireless communications. In some aspects, an apparatus for wireless communications is provided. The apparatus includes at least one energy storage clement, at least one memory, and at least one processor coupled to the at least one memory and configured to: receive one or more energizing signals from one or more energizing devices; store, in the at least one energy storage element, energy from the one or more energizing signals; determine a quality metric based on at least one of the apparatus, the one or more energizing signals, or the one or more energizing devices; and output, for transmission to a network entity via one or more wireless communication devices based on the energy stored in the apparatus, a beacon including the quality metric for the network entity to determine one or more subsequent energizing signals.

In some aspects, a method is provided for wireless communications at a computing device. The method includes: receiving one or more energizing signals from one or more energizing devices; storing, in the computing device, energy from the one or more energizing signals; determining a quality metric based on at least one of the computing device, the one or more energizing signals, or the one or more energizing devices; and transmitting, to a network entity via one or more wireless communication devices based on the energy stored in the computing device, a beacon including the quality metric for the network entity to determine one or more subsequent energizing signals.

In some aspects, a non-transitory computer-readable medium of a computing device is provided having stored thereon instructions that, when executed by at least one processor, cause the at least one processor to: receive one or more energizing signals from one or more energizing devices; store, in the at least one energy storage element, energy from the one or more energizing signals; determine a quality metric based on at least one of the computing device, the one or more energizing signals, or the one or more energizing devices; and output, for transmission to a network entity via one or more wireless communication devices based on the energy stored in the computing device, a beacon including the quality metric for the network entity to determine one or more subsequent energizing signals

In some aspects, an apparatus is provided for wireless communications. The apparatus includes: means for receiving one or more energizing signals from one or more energizing devices; means for storing energy from the one or more energizing signals; means for determining a quality metric based on at least one of the apparatus, the one or more energizing signals, or the one or more energizing devices; and means for transmitting, to a network entity via one or more wireless communication devices based on the energy stored in the apparatus, a beacon including the quality metric for the network entity to determine one or more subsequent energizing signals.

In some aspects, a network entity for wireless communications is provided. The network entity includes at least one memory and at least one processor coupled to the at least one memory and configured to: receive, from one or more computing devices via one or more wireless communication devices, one or more beacons; determine, based on information within the one or more beacons, a respective transmit power for each energizing signal of one or more energizing signals; and output, for transmission to one or more energizing devices, one or more command signals commanding the one or more energizing devices to sequentially transmit the one or more energizing signals with each respective transmit power.

In some aspects, a method is provided for wireless communications at a network entity. The method includes: receiving, from one or more computing devices via one or more wireless communication devices, one or more beacons; determining, based on information within the one or more beacons, a respective transmit power for each energizing signal of one or more energizing signals; and transmitting, to one or more energizing devices, one or more command signals commanding the one or more energizing devices to sequentially transmit the one or more energizing signals with each respective transmit power.

In some aspects, a non-transitory computer-readable medium of a network entity is provided having stored thereon instructions that, when executed by at least one processor, cause the at least one processor to: receive, from one or more computing devices via one or more wireless communication devices, one or more beacons; determine, based on information within the one or more beacons, a respective transmit power for each energizing signal of one or more energizing signals; and output, for transmission to one or more energizing devices, one or more command signals commanding the one or more energizing devices to sequentially transmit the one or more energizing signals with each respective transmit power.

In some aspects, a network entity is provided for wireless communications. The network entity includes: means for receiving, from one or more computing devices via one or more wireless communication devices, one or more beacons; means for determining, based on information within the one or more beacons, a respective transmit power for each energizing signal of one or more energizing signals; and means for transmitting, to one or more energizing devices, one or more command signals commanding the one or more energizing devices to sequentially transmit the one or more energizing signals with each respective transmit power.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2A is a diagram illustrating example components of a device, in accordance with some aspects of the present disclosure.

FIG. 2B is a diagram illustrating an example of a radio frequency (RF) energy harvesting device (e.g., an ambient IOT device), in accordance with aspects of the present disclosure.

FIG. 3 is a diagram illustrating an example of a system, in accordance with aspects of the present disclosure.

FIG. 4 is a diagram illustrating an example of a wireless communication devices equipped with radios, in accordance with aspects of the present disclosure.

FIG. 5 is a diagram illustrating an example of a convex region formed by wireless communication devices equipped with radios, in accordance with aspects of the present disclosure.

FIG. 6 is a signaling diagram illustrating example communication transmissions, in accordance with some aspects of the present disclosure.

FIG. 7 is a signaling diagram illustrating an example of communication transmissions between a network device and two groups of wireless communication devices, in accordance with some aspects of the present disclosure.

FIG. 8 is a signaling diagram illustrating examples of communication transmissions, in accordance with some aspects of the present disclosure.

FIG. 9 is a flow diagram illustrating an example of a process for uplink scheduling for ambient IOT devices, in accordance with some aspects of the present disclosure.

FIG. 10 is a diagram illustrating an example for selectively energizing ambient IOT devices, in accordance with some aspects of the present disclosure.

FIG. 11 is a flow diagram illustrating an example of a process for wireless communications at a computing device, in accordance with some aspects of the disclosure.

FIG. 12 is a flow diagram illustrating an example of a process for wireless communications at a network entity, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Short range wireless communication protocols enable wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz. BLUETOOTH® Low Energy (BLE) is a form of BLUETOOTH® communication that allows for communication with devices that operate using low power. Such devices may include wireless communication devices that can use low-energy communication technology for positioning, proximity marketing, or other purposes.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME) or edge server, via at least one network device, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME (e.g., edge server), each peripheral device (e.g., ESL) may have a wireless connection (e.g., a BLE connection or other connection) to an AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for ESL systems to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

Each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

In some cases, an ESL may lose synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. PAwR allows BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices. When the ESLs are powered, the ESLs can scan to receive a wake up packet (WUP) from the access point. The WUP can contain advertisement parameters for the ESLs. Upon receiving the WUP from the access point, the ESLs can transmit advertisement messages (e.g., a connectable advertisement (CAP)) on a legacy channel based on parameters (e.g., interval and duration parameters) received within the WUP. The access point can scan to receive the CAPs from the ESLs, and then create a generic attribute profile (GATT) connection with one of the advertising ESLs to perform onboarding of that ESL. The onboarding process involves the transfer of periodic advertisement synchronization transfer (PAST) information, where an access point can share its PAwR timing with the ESL. When multiple access points receive a CAP from an ESL, the access points can report the received CAP to the management entity. The management entity can then shortlist one of the access points to onboard the ESL.

A system (e.g., a system for asset tracking, monitoring, and/or supply chain management purposes, such as in a retail store or warehouse environment) may include one or more wireless communication devices that are controlled by a network entity. For example, a system may include one or more peripheral devices (e.g., wireless communication devices, such as in the form of ESLs) that are controlled by a network entity (e.g., an edge server) via at least one network device (e.g., an access point). In one or more examples, to facilitate control by the network entity (e.g., the edge server), each peripheral device (e.g., ESL) may have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the edge server) may be wirelessly transmitted to the peripheral devices (e.g., ESLs) by the network device (e.g., the access point). Responses or information from the peripheral devices may also be received by the network device, and provided by the network device to the network entity (e.g., by the access point to the edge server).

The peripheral devices in the system may include a plurality of ambient internet of things (IOT) devices (as examples of wireless communication devices or peripheral devices), which may each be in the form of a low cost, batteryless, energy harvesting tag, such as an electronic tag (eTag). One or more of the ambient IOT devices (e.g., tags) can each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), can interrogate, scan, read, probe, and/or energize the ambient IOT devices. Such energizing devices can be in the form of mobile devices (e.g., smart phones, tablet computers, handheld reader devices, etc.), robots, forklifts, or other devices.

The ambient IOT devices (e.g., being batteryless) may be powered by harvesting energy (e.g., power) from signals (e.g., energizing signals, RF signals, sweeping beams, or energizing waveforms) transmitted from the devices (such as energizing devices). After being energized, the ambient IOT devices can each transmit a response signal (e.g., a beacon) including some identifying information (e.g., metadata) that is unique to each ambient IOT device. Near field communication (NFC) tags can support communication as well. An edge server may store and maintain a database of information pertaining to the ambient IOT devices (e.g., information related to their capabilities and last known locations).

Currently, low-cost ambient IOT devices (e.g., in the form of tags, such as eTags) are expected to be pervasively deployed for the purposes of asset tracking, monitoring, and supply chain management, particularly in environments, such as retail stores and warehouses. These ambient IOT devices are also expected to be battery-less, and are powered through energy harvesting from radio waves. These ambient IOT devices are also expected be incapable of demodulating control information and cannot be scheduled for transmissions. Dedicated devices (e.g., energizing devices), equipped with superior power resources, may be deployed across a retail store, primarily to energize ambient IOT devices located within the vicinity.

After being energized, an ambient IOT device (e.g., eTag) may randomly select a time slot and, then, may transmit a beacon (e.g., over 2.4 Gigahertz (GHz)) within the selected time slot. The beacon can contain an identification (ID), such as a medium access control (MAC) address, associated with the ambient IOT device along with some payload (e.g., which may include sensor measurements obtained by the ambient IOT device related to temperature, etc.).

The beacon may be received by one or more wireless communication devices (e.g., ESL radios associated with one or more ESLs). The ESL radios may measure the signal strength, such as a received signal strength indicator (RSSI), of the received beacon from the ambient IOT device. The measured signal strength can be used (e.g., by an edge server) to estimate a position of the ambient IOT device.

However, ESL radios are battery constrained and, as such, cannot scan and listen for the beacons all of the time, because doing so would cause their batteries to become quickly depleted. Furthermore, another concern is UL interference between simultaneous transmissions from multiple ambient IOT devices (e.g., eTags). As such, improved systems and techniques for reducing power consumption of wireless communication devices (e.g., ESL radios) and UL interference from ambient IOT devices (e.g., eTags) transmissions can be beneficial.

In one or more aspects of the present disclosure, systems, apparatuses, methods (also referred to as processes), and computer-readable media (collectively referred to herein as “systems and techniques”) are described herein that provide solutions for reducing power consumption and UL interference based on feedback from ambient IOT tags.

Various aspects relate generally to wireless communications. Some aspects more specifically relate to systems and techniques that provide “green communication” solutions for conserving batteries at both the ESL radios and the energizing devices, and for reducing inter-eTag UL interference through a protocol implemented at the energizing devices and the eTags. In one or more examples, eTags can embed a quality metric (e.g., related to their received energizing signals) within payloads of their beacon signals. In some examples, energizing devices can adapt their energizing signal power to reduce UL interference. In one or more examples, ESL radios can be scheduled to “wake up” and scan for beacons based on the quality metric.

In one or more aspects, during operation for wireless communications at a computing device, a computing device can receive one or more energizing signals from one or more energizing devices. The computing device can store, in the computing device, energy from the one or more energizing signals. The computing device can determine a quality metric based on the computing device, the one or more energizing signals, and/or the one or more energizing devices. The computing device can transmit, to a network entity via one or more wireless communication devices based on the energy stored in the computing device, a beacon including the quality metric for the network entity to determine one or more subsequent energizing signals.

In one or more examples, the quality metric can be associated with an amount of charge stored within the computing device, a number of energizing devices of the one or more energizing devices, a signal strength for each energizing signal of the one or more energizing signals, and/or an indicator for each of the energizing devices of the one or more energizing devices indicating whether the energizing device is within a network including the computing device. In some examples, transmitting the beacon can be further based on a duration of time elapsing after the computing device receive the one or more energizing signals. In one or more examples, the duration of time can be based on a transmission indicator value (e.g., a Q-value) within the one or more energizing signals. In some examples, the transmission indicator value (e.g., the Q-value) can bound a random number for determining a time slot for transmission of the beacon. In one or more examples, transmitting the beacon can be further based on an amount of charge stored within the computing device. In some examples, the computing device can be an ambient IOT device. In one or more examples, each wireless communication device of the one or more wireless communication devices can be an electronic shelf label radio. In some examples, the network entity can be a management entity.

In one or more aspects, during operation for wireless communications at a network entity, the network entity can receive, from one or more computing devices via one or more wireless communication devices, one or more beacons. The network entity can determine, based on information within the one or more beacons, a respective transmit power for each energizing signal of one or more energizing signals. The network entity can transmit, to one or more energizing devices, one or more command signals commanding the one or more energizing devices to sequentially transmit the one or more energizing signals with the respective transmit powers.

In one or more examples, determining the respective transmit power for each energizing signal of one or more energizing signals can be based on a water-filling algorithm to trigger sequential transmissions by the one or more computing devices. In some examples, the one or more command signals can include beam weights for beamforming to direct the transmissions of the one or more energizing signals. In one or more examples, the one or more command signals can include one or more transmission indicator values (e.g., Q-values).

In some examples, the network entity can transmit, to at least one of the one or more wireless communication devices, a start time for receiving one or more subsequent beacons from the one or more computing devices, an end time for receiving the one or more subsequent beacons from the one or more computing devices, and a certain periodicity or duty cycle for receiving between the start time and the end time. In one or more examples, the one or more beacons can be received from the one or more wireless communication devices via a network device. In one or more examples, the network device can be an access point. In some examples, each computing device of the one or more computing devices can be an ambient IOT device. In one or more examples, the network entity can be a management entity. In some examples, each wireless communication device of the one or more wireless communication devices can be an electronic shelf label radio.

Particular aspects of the subject matter described in this disclosure can be implemented to realize one or more of the following potential advantages. In one or more examples, the systems and techniques can provide a benefit of reducing power consumption for batteries associated with ESL radios and energizing devices. In some examples, the systems and techniques can provide a benefit of reducing UL interference from simultaneous transmissions by multiple ambient IOT devices (e.g., eTags).

Additional aspects of the present disclosure are described in more detail below.

As used herein, the term “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

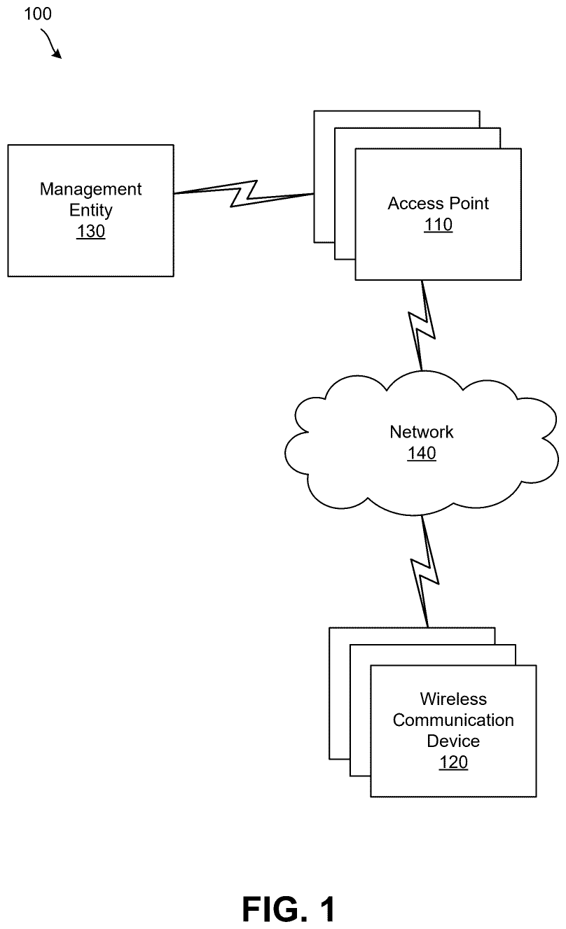

According to various aspects, FIG. 1 is a diagram of an example environment 100 in which systems and/or methods described herein may be implemented. As shown in FIG. 1, the environment 100 may include at least one access point (AP) 110 (e.g., a network device), at least one wireless communication device 120 (e.g., at least one ESL), a management entity (ME) 130 (e.g., a network entity), and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

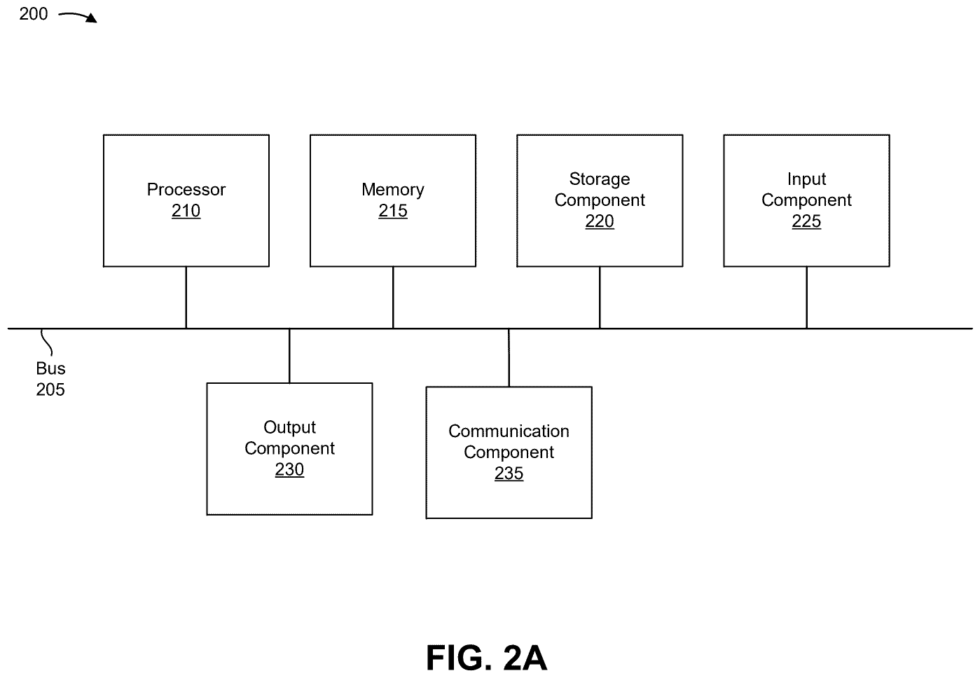

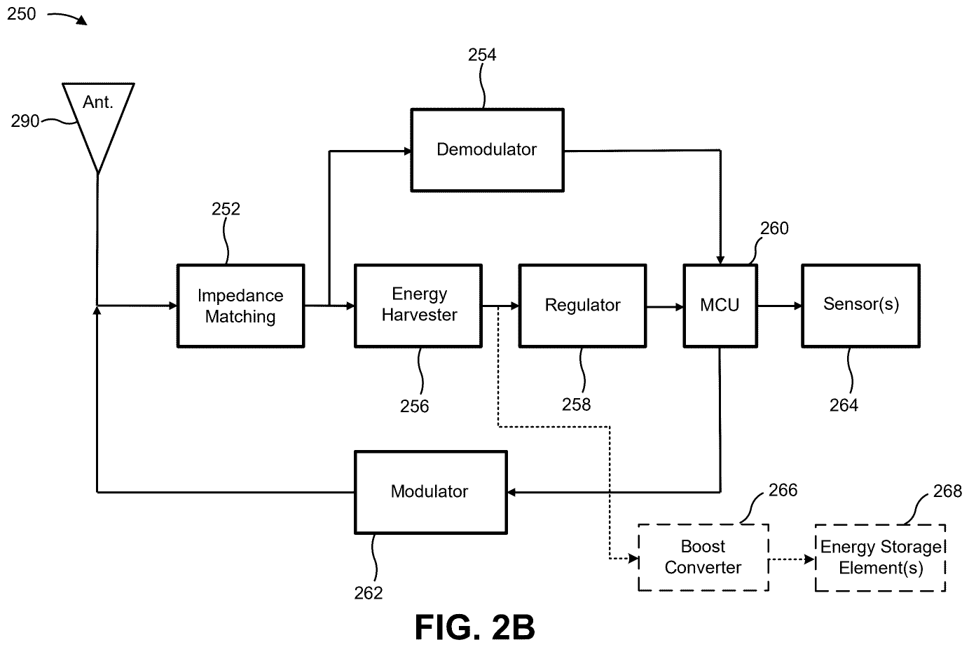

FIG. 2A is a diagram illustrating example components of a device 200, in accordance with the present disclosure. Device 200 may correspond to access point 110, wireless communication device 120 (e.g., an ESL), and/or management entity 130. In some aspects, access point 110, wireless communication device 120, and/or management entity 130 may include one or more devices 200 and/or one or more components of device 200. As shown in FIG. 2A, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2A are provided as an example. In practice, device 200 may include additional components, fewer components, different components, or differently arranged components than those shown in FIG. 2A. Additionally, or alternatively, a set of components (e.g., one or more components) of device 200 may perform one or more functions described as being performed by another set of components of device 200.

FIG. 2B is a diagram illustrating an example of an architecture of a radio frequency (RF) energy harvesting device 250, in accordance with the present disclosure. As will be described in greater depth below, the RF energy harvesting device 250 can harvest RF energy from one or more RF signals received using an antenna 290. As used herein, the term “energy harvesting” may be used interchangeably with “power harvesting.” In some aspects, energy harvesting device 250 can be implemented as an Internet-of-Things (IOT) device, can be implemented as a sensor, etc., as will be described in greater depth below. In other examples, energy harvesting device 250 can be implemented as a Radio-Frequency Identification (RFID) tag or various other RFID devices.

The energy harvesting device 250 includes one or more antennas 290 that can be used to transmit and receive one or more wireless signals. For example, energy harvesting device 250 can use antenna(s) 290 to receive one or more downlink signals and to transmit one or more uplink signals. An impedance matching component 252 can be used to match the impedance of antenna(s) 290 to the impedance of one or more (or all) of the receive components included in energy harvesting device 250. In some examples, the receive components of energy harvesting device 250 can include a demodulator 254 (e.g., for demodulating a received downlink signal), an energy harvester 256 (e.g., for harvesting RF energy from the received downlink signal), a regulator 258, a micro-controller unit (MCU) 260, a modulator 262 (e.g., for generating an uplink signal). In some cases, the receive components of energy harvesting device 250 may further include one or more sensors 264.

The downlink signals can be received from one or more transmitters. For example, energy harvesting device 250 may receive a downlink signal from a network node or network entity that is included in a same wireless network as the energy harvesting device 250. In some cases, the network entity can be a base station, gNB, etc., that communicates with the energy harvesting device 250 using a cellular communication network. For example, the cellular communication network can be implemented according to the 3G, 4G, 5G, and/or other cellular standard (e.g., including future standards such as 6G and beyond).

In some cases, energy harvesting device 250 can be implemented as a passive or semi-passive energy harvesting device (e.g., an ambient energy harvesting device), which can perform passive uplink communication by modulating and reflecting a downlink signal received via antenna(s) 290. For example, passive and semi-passive energy harvesting devices may be unable to generate and transmit an uplink signal without first receiving a downlink signal that can be modulated and reflected. In other examples, energy harvesting device 250 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device, also referred to herein as an ambient IOT device) may include one or more energy storage elements 268 (e.g., collectively referred to as an “energy reservoir”). For example, the one or more energy storage elements 268 can include batteries, capacitors, any combination thereof, and/or other storage element(s). In some examples, the one or more energy storage elements 268 may be associated with a boost converter 266. The boost converter 266 can receive as input at least a portion of the energy harvested by energy harvester 256 (e.g., with a remaining portion of the harvested energy being provided as instantaneous power for operating the energy harvesting device 250). In some aspects, the boost converter 266 may be a step-up converter that steps up voltage from its input to its output (e.g., and steps down current from its input to its output). In some examples, boost converter 266 can be used to step up the harvested energy generated by energy harvester 256 to a voltage level associated with charging the one or more energy storage elements 268. An ambient energy harvesting device (e.g., active or semi-passive energy harvesting device) may include one or more energy storage elements 268 and may include one or more boost converters 266. A quantity of energy storage elements 268 may be the same as or different than a quantity of boost converters 266 included in an active or semi-passive energy harvesting device.

A passive energy harvesting device does not include an energy storage element 268 or other on-device power source. For example, a passive energy harvesting device may be powered using only RF energy harvested from a downlink signal (e.g., using energy harvester 256). As mentioned previously, a semi-passive energy harvesting device can include one or more energy storage elements 268 and/or other on-device power sources. The energy storage element 268 of a semi-passive energy harvesting device can be used to augment or supplement the RF energy harvested from a downlink signal. In some cases, the energy storage element 268 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 268 and/or other on-device power sources that can power uplink communication without using supplemental harvested RF energy (e.g., minimum transmit power of the active device<capacity of the energy storage element). The energy storage element(s) 268 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage clement to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 250 is implemented as an ambient energy harvesting device (e.g., a passive or semi-passive energy harvesting device), a continuous carrier wave downlink signal may be received using antenna(s) 290 and modulated (e.g., re-modulated) for uplink communication. In some cases, the modulator 262 can be used to modulate the reflected (e.g., backscattered) portion of the downlink signal. For example, the continuous carrier wave may be a continuous sinusoidal wave (e.g., sine or cosine waveform) and modulator 262 can perform modulation based on varying one or more of the amplitude and the phase of the backscattered reflection. Based on modulating the backscattered reflection, modulator 262 can encode digital symbols (e.g., such as binary symbols or more complex systems of symbols) indicative of an uplink communication or data message. For example, the uplink communication may be indicative of sensor data or other information associated with the one or more sensors 264 included in energy harvesting device 250.

As mentioned previously, impedance matching component 252 can be used to match the impedance of antenna(s) 290 to the receive components of energy harvesting device 250 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 290. Based on varying the antenna impedance (e.g., varying the impedance mismatch between antenna(s) 290 and the remaining components of energy harvesting device 250), digital symbols and/or binary information can be encoded (e.g., modulated) onto the backscattered reflection. Varying the antenna impedance to modulate the phase and/or amplitude of the backscattered reflection can be performed using modulator 262.

As illustrated in FIG. 2B, a portion of a downlink signal received using antenna(s) 290 can be provided to a demodulator 254, which performs demodulation and provides a downlink communication (e.g., carried or modulated on the downlink signal) to a micro-controller unit (MCU) 260 or other processor included in the energy harvesting device 250. A remaining portion of the downlink signal received using antenna(s) 290 can be provided to energy harvester 256, which harvests RF energy from the downlink signal. For example, energy harvester 256 can harvest RF energy based on performing AC-to-DC (alternating current-to-direct current) conversion, wherein an AC current is generated from the sinusoidal carrier wave of the downlink signal and the converted DC current is used to power the energy harvesting device 250. In some aspects, energy harvester 256 can include one or more rectifiers for performing AC-to-DC conversion. A rectifier can include one or more diodes or thin-film transistors (TFTs). In one illustrative example, energy harvester 256 can include one or more Schottky diode-based rectifiers. In some cases, energy harvester 256 can include one or more TFT-based rectifiers.

The output of the energy harvester 256 is a DC current generated from (e.g., harvested from) the portion of the downlink signal provided to the energy harvester 256. In some aspects, the DC current output of energy harvester 256 may vary with the input provided to the energy harvester 256. For example, an increase in the input current to energy harvester 256 can be associated with an increase in the output DC current generated by energy harvester 256. In some cases, MCU 260 may be associated with a narrow band of acceptable DC current values. Regulator 258 can be used to remove or otherwise decrease variation(s) in the DC current generated as output by energy harvester 256. For example, regulator 258 can remove or smooth spikes (e.g., increases) in the DC current output by energy harvester 256 (e.g., such that the DC current provided as input to MCU 260 by regulator 258 remains below a first threshold). In some cases, regulator 258 can remove or otherwise compensate for drops or decreases in the DC current output by energy harvester 256 (e.g., such that the DC current provided as input to MCU 260 by regulator 258 remains above a second threshold).

In some aspects, the harvested DC current (e.g., generated by energy harvester 256 and regulated upward or downward as needed by regulator 258) can be used to power MCU 260 and one or more additional components included in the energy harvesting device 250. For example, the harvested DC current can additionally be used to power one or more (or all) of the impedance matching component 252, demodulator 254, regulator 258, MCU 260, sensors 264, modulator 262, etc. For example, sensors 264 and modulator 262 can receive at least a portion of the harvested DC current that remains after MCU 260 (e.g., that is not consumed by MCU 260). In some cases, the harvested DC current output by regulator 258 can be provided to MCU 260, modulator 262, and sensors 264 in series, in parallel, or a combination thereof.

In some examples, sensors 264 can be used to obtain sensor data (e.g., such as sensor data associated with an environment in which the energy harvesting device 250 is located). Sensors 264 can include one or more sensors, which may be of a same or different type(s). In some aspects, one or more (or all) of the sensors 264 can be configured to obtain sensor data based on control information included in a downlink signal received using antenna(s) 290. For example, one or more of the sensors 264 can be configured based on a downlink communication obtained based on demodulating a received downlink signal using demodulator 254. In one illustrative example, sensor data can be transmitted based on using modulator 262 to modulate (e.g., vary one or more of amplitude and/or phase of) a backscatter reflection of the continuous carrier wave received at antenna(s) 290. Based on modulating the backscattered reflection, modulator 262 can encode digital symbols (e.g., such as binary symbols or more complex systems of symbols) indicative of an uplink communication or data message. In some examples, modulator 262 can generate an uplink, backscatter modulated signal based on receiving sensor data directly from sensors 264. In some examples, modulator 262 can generate an uplink, backscatter modulated signal based on received sensor data from MCU 260 (e.g., based on MCU 260 receiving sensor data directly from sensors 264).

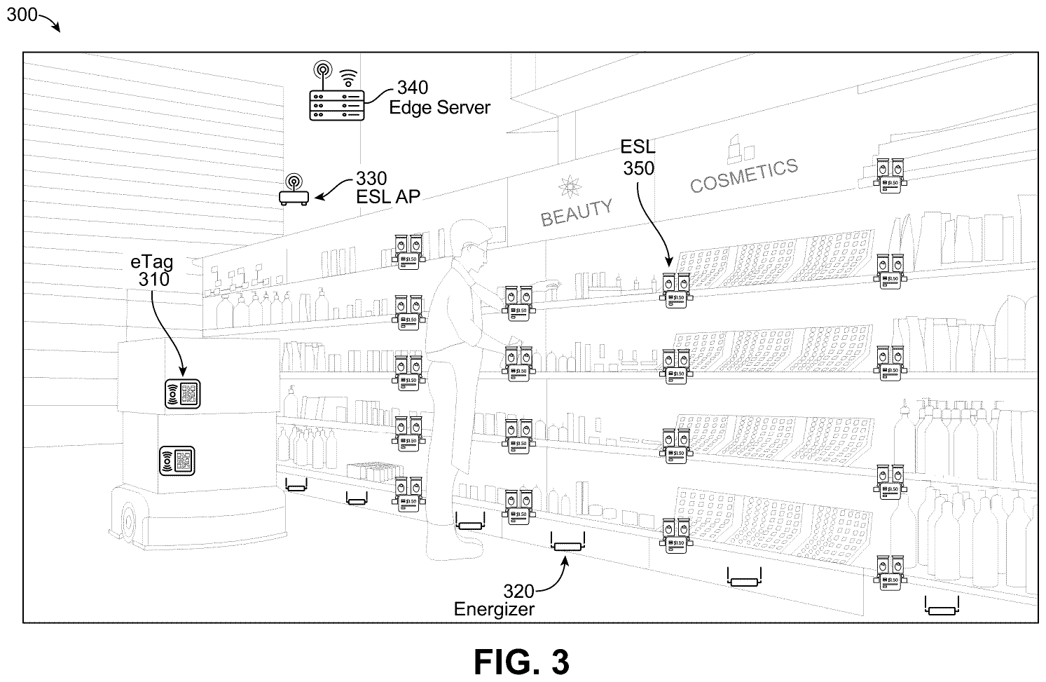

As previously mentioned, a system (e.g., a system for asset tracking, monitoring, and/or supply chain management purposes, such as in a retail store or warehouse environment) can include one or more wireless communication devices that are controlled by a network entity. For example, a system may include one or more peripheral devices (e.g., wireless communication devices, such as wireless communication devices 120 of FIG. 1, for example in the form of ESLs) that are controlled by a network entity (e.g., an edge server, such as network entity 340 of FIG. 3) via at least one network device (e.g., an access point, such as access point 110 of FIG. 1). In one or more examples, to facilitate control by the network entity (e.g., the edge server), each peripheral device (e.g., ESL) can have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the edge server) can be wirelessly transmitted to the peripheral devices (e.g., ESLs) by the network device (e.g., the access point). Responses or information from the peripheral devices can also be received by the network device, and provided by the network device to the network entity (e.g., by the access point to the edge server).

The peripheral devices in the system can include a plurality of ambient IOT devices (as examples of wireless communication devices or peripheral devices), which may each be in the form of a low cost, batteryless, energy harvesting tag (e.g., ambient IOT devices 310 of FIG. 3). One or more of the ambient IOT devices (e.g., ambient IOT tags) may each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”, such as energizing devices 320 of FIG. 3), may interrogate, scan, read, probe, and/or energize the ambient IOT devices. Such devices may be in the form of mobile devices (e.g., smart phones, tablet computers, handheld reader devices, etc.), robots, forklifts, or other devices.

The ambient IOT devices, being batteryless, can be powered by harvesting energy (e.g., power) from signals (e.g., energizing signals, RF signals, sweeping beams, or energizing waveforms) transmitted from the devices (e.g., the energizing devices). After being energized, the ambient IOT devices may each transmit a response signal including some identifying information (e.g., metadata) that is unique to each ambient IOT device. NFC tags may support communication as well. The edge server can store and maintain a database of information pertaining to the ambient IOT devices (e.g., information related to their capabilities and last known locations).

In one or more aspects, the system (e.g., including energizing devices) can be utilized to trigger ambient IOT devices to send response signals including their respective identifying information. In one or more examples, ambient IOT devices of a system (e.g., deployed within a retail store) may be configured to transmit beacon frames (e.g., response signals, which may include identifying information associated with the ambient IOT devices).

FIG. 3 shows an example of system (e.g., deployed within a retail store). In particular, FIG. 3 is a diagram illustrating an example of an system 300. In FIG. 3, the system 300 is shown to be located within a retail store. The system 300 is shown to include a network entity 340 (e.g., in the form of an edge server or gateway node or management entity, which may be located within the retail store), a network device 330 (e.g., an access point, which may be located within the retail store), ambient IOT devices 310 (e.g., energy harvesting BLE tags, for example eTags, that are each associated with a parcel), energizing devices 320 (e.g., energizers mounted on the shelving units within the retail store), and wireless communication devices 350 (e.g., in the form of ESLs that are mounted on the shelving units, where the ESLs are powered and controlled by an electric rail mounted within the shelving units, and the ESLs are associated with ESL radios).

In one or more aspects, the energizing devices 320 (e.g., energizers mounted on a shelf, mobile devices, such as a smart phone, a robot, a fork lift, etc.) may have one or more capabilities. In one or more examples, the energizing devices 320 may have a capability of supporting RFID technology, which may include the ability to read and scan an ambient IOT device 310 (e.g., in the form of an RFID tag, such as an eTag), and include the ability to support communications using one or more frequency bands related to RFID technology, such as low frequency (LF), high frequency (HF), near field communication (NFC) frequency, and ultra-high frequency (UHF). In some examples, the energizing devices 310 may have an energizing capability, which can include the ability to energize an ambient IOT device 310 and to instruct the ambient IOT device 310 to communicate (e.g., via a broadcast or a unicast) with another device (e.g., communicate information about a particular item to an access point, such as for inventory purposes). In one or more examples, the energizing devices 320 may have a capability to support beamforming (e.g., a beamforming capability to be able to form an antenna beam and scan, for example steer, the beam towards a particular ambient IOT device 310), such as for the purpose of interrogating the ambient IOT device 310.

In one or more examples, the energizing devices 320 may have a capability to support radio communications, such as radio frequency (RF) communications (e.g., using cellular, satellite, Wi-Fi, and/or Bluetooth communications). For example, the energizing devices 320 may be able to receive transmissions (e.g., RF signal transmissions) from one or more ambient IOT devices 310 (e.g., each in the form of a tag, such as an eTag), such as for the purpose of relaying the received information to a network device 330 (e.g., access point) and a network entity 340 (e.g., an edge server).

In some examples, the energizing devices 320 may have a capability of including a camera for capturing images and/or video of the surrounding environment (e.g., within the retail store or warehouse). The energizing devices 320 may receive information (e.g., about a product associated with an ambient IOT device 310) via images taken by the camera of the local environment.

In one or more examples, the energizing devices 320 may have a capability of having transparency, which may include an ability to share information associated with one or more ambient IOT devices 310, which may each be in the form of a tag (e.g., an eTag), with a network entity 340, such as an edge server. In some examples, the energizing devices 320 may have the capability to share information (e.g., prices, expiration dates, and/or online reviews related to the items associated with the ambient IOT devices 310) to a user or a store employee by displaying the information on a graphical user interface (GUI), which may be implemented within the energizing devices 320. In one or more examples, when an energizing device 320 is able to share information associated with one or more ambient IOT devices 310, there may be an expected latency (e.g., an expected amount of delay in time) in the energizing device 320 delivering the information to the network entity 340, such as an edge server.

In one or more aspects, ambient IOT devices 310, which may each be in the form of a tag (e.g., an eTag), may have one or more capabilities. In one or more examples, the ambient IOT devices 310 may be part of a larger system, such as a system that includes wireless communication devices 350 (e.g., ESLs) and/or rail controllers, which may each be equipped with wireless radios (e.g., RF radios, such as ESL radios) and/or cameras.

In one or more examples, the ambient IOT devices 310 may have one or more of the same capabilities as previously mentioned for the energizing devices 320, except for the energizing and beamforming capabilities. For example, the ambient IOT devices 310 may have capabilities including the ability to support RFID technology (e.g., which can include the ability to harvest energy from received signals (energizer signals or transmissions) from energizing devices 320 and to transmit identifying information after being sufficiently energized with power), the ability to operate as a radio (e.g., the ability to receive transmissions from energizing devices 320 and to transmit signals to the energizing devices 320 and/or to the wireless communication devices 350), the ability to operate as a camera, and/or the ability to operate with transparency (e.g., by sharing identifying information for itself with energizing devices 320).

During operation of the system 300 of FIG. 3 within a retail store scenario, the energizing devices 320 can send (e.g., transmit) energizer signals (e.g., energizer transmissions) to the ambient IOT devices 310. The ambient IOT devices 310 can receive the energizer signals and harvest energy from the energizer signals to energize themselves. After the ambient IOT devices 310 have harvested enough energy to be able to transmit, the ambient IOT devices 310 (e.g., eTags) can send (e.g., transmit) beacons (e.g., beacon frames).

In one or more examples, the wireless communication devices 350 (e.g., ESL radios associated with ESLs), which are located within the vicinity of the ambient IOT devices 310 (e.g., tags), can receive the beacons transmitted from the ambient IOT devices 310 (e.g., eTags). In some examples, receivers (e.g., associated with the ESL radios) may receive the beacons, may obtain information from the beacons (e.g., information related to the ambient IOT devices 310 themselves, such as unique identifying information, and/or information related to items or product associated with the ambient IOT devices 310), and may obtain measurements (e.g., signal strength measurements, such as RSSIs) of the received beacons. In response to receiving the beacons, the receivers may not perform an interrogation itself, but rather may relay the information within and/or associated with (e.g., measurements, such as the RSSIs) the beacons to the network entity 340 (e.g., an edge server) via the network device 330 (e.g., access point).

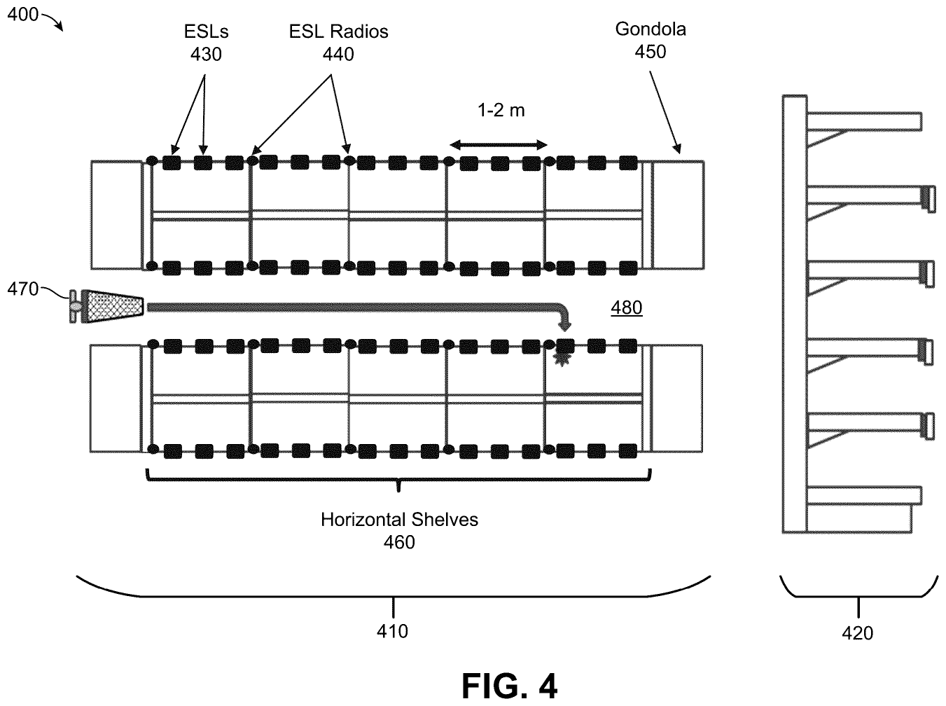

FIG. 4 shows an example configuration of wireless communication devices (e.g., the wireless communication devices 350) installed on shelves. In particular, FIG. 4 is a diagram illustrating a system 400 of a wireless communication devices (e.g., ESLs) equipped with radios (e.g., ESL radios) installed on shelves. While ESLs and ESL radios are illustrated as examples of wireless communication devices, other types of wireless communication devices can be included in the system 400 (e.g., internet of things (IOT) devices, such as ambient IOT devices).

In FIG. 4, two views of a retail store are shown. The two views include a top view 410 of the store (e.g., including two gondolas 450 in the form of shelving units) and a side view 420 of the store (e.g., including a side view of one of the gondolas 450). In the top view 410, each of the gondolas 450 (e.g., shelving units) includes a plurality of (e.g., five, or up to a total of six) horizontal shelves 460. The two gondolas 450 (e.g., shelving units) are shown to be parallel to each other and divided by an aisle 480.

In the top view 410 of FIG. 4, a plurality of wireless communication devices in the form of ESLs 430 are shown to be mounted and installed on the horizontal shelves 460. Each of the ESLs 430 may be equipped with a display and/or a camera. A plurality of wireless communication devices in the form of ESL radios 440 are also shown to be mounted and installed on the horizontal shelves 460 and interspersed in between multiple ESLs 430. For example, as shown in FIG. 4, each ESL radio 440 is shown to be located in between three ESLs 430. In one or more examples, one or more ESLs 430 (e.g., three ESLs 430) may be associated with (e.g., linked to) a single, common, ESL radio 440. In some examples, a group of ESLs 430 may be associated with a single, common, ESL radio 440. In some examples, the ESL radios 440 may be deployed such that they are located apart from each other by a distance of one to two meters (m).

In some examples, the ESL radios 440 (e.g., which can each include a transmit and receive antenna(s)) can each be employed as an “anchor node” for positioning of ambient IOT devices (e.g., ambient IOT devices 310 of FIG. 3, which may be in the form of eTags). In one or more examples, a shopping cart 470 (e.g., including an energizing device) is shown to be travelling down the aisle 480 located between the gondolas 450 (e.g., the shelving units). The shopping cart 470 may include an energizing device (e.g., an energizing devices 320 of FIG. 3) that can send (e.g., transmit) energizing signals to energize nearby ambient IOT devices (e.g., the ambient IOT devices 310 of FIG. 3, which may be in the form of eTags). After the ambient IOT devices have a sufficient amount of charge (e.g., from the energizing signals) to transmit, the ambient IOT devices may transmit beacons (e.g., beacon frames or beacon signals). The ESL radios 440 may receive the beacons from the ambient IOT devices, may obtain information from the beacons (e.g., information related to the ambient IOT devices themselves and/or information related to items or product associated with the ambient IOT devices), and may obtain measurements (e.g., signal strength measurements, such as RSSIs) of the received beacons. The ESL radios 440 may relay the information within and/or associated with (e.g., measurements, such as the RSSIs) the beacons to a network entity (e.g., the network entity 340 of FIG. 3, such as an edge server) via a network device (e.g., the network device 330 of FIG. 3, such as an access point).

In one or more examples, the network entity (e.g., the network entity 340, which may be in the form of an edge server) may determine (e.g., compute) a position (e.g., an estimated location) for an ambient IOT device (e.g., ambient IOT device 310 of FIG. 3) based on signal strengths (e.g., RSSIs) measured by the ESL radios 440 of the beacons transmitted from that ambient IOT device (e.g., ambient IOT device 310 of FIG. 3).

Trilateration using RSSIs for position estimation has been observed to be highly unreliable since the RSSIs are very susceptible to attenuation, which in turn can lead to poor range estimation accuracy. The Weighted Centroid Algorithm (WCA) has been seen to be much more robust to attenuation and non-line of sight (NLOS) effects.

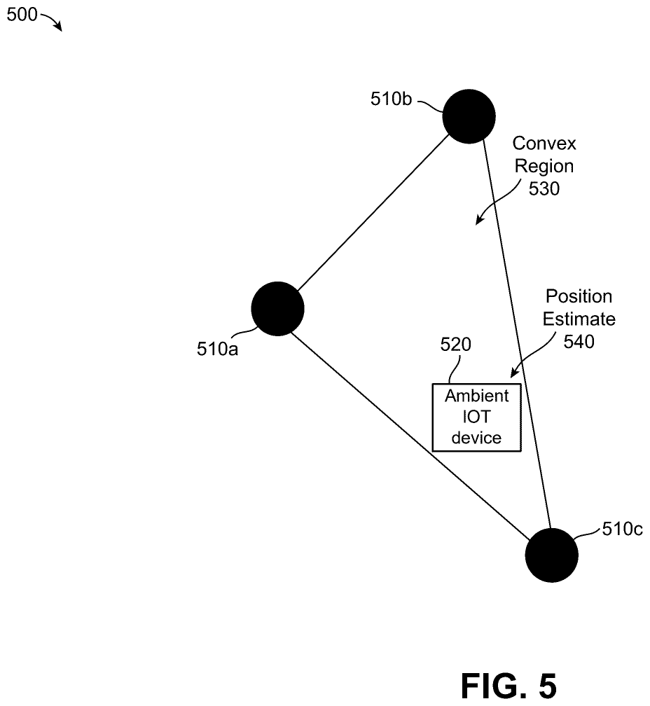

FIG. 5 shows an example of position estimation of an ambient IOT device 520 (e.g., in the form of an eTag) using an RSSI-weighted centroid algorithm (e.g., WCA). In particular, FIG. 5 is a diagram illustrating an example 500 of a convex region 530 formed by ESL radios (e.g., ESL 1 510a, ESL 2 510b, ESL 3 510c).

For example, for a given ambient IOT device (e.g., ambient IOT device 520, which may be in the form of an eTag), let r₁≥r₂≥ . . . r_{M} denote the RSSI values for M number of ESL radios (e.g., ESL 1 510a, ESL 2 510b, ESL 3 510c) in descending order. The position estimate for the ambient IOT device (e.g., ambient IOT device 520) can then be given by the weighted average of the known positions of the ESL radios (e.g., ESL 1 510a, ESL 2 510b, ESL 3 510c), where the weights may be a function of the RSSI values. As such, the position (e.g., position estimate 540) for the ambient IOT device (e.g., ambient IOT device 520) may be determined by using the following equations:

$$\hat{P} = \frac{{\sum }_{k = 1}^{N} {w}_{k} \cdot {P}_{k}}{{\sum }_{k = 1}^{N} {w}_{k}} \qquad [ equation 1 ]$$

$${w}_{k} = {2}^{\frac{{r}_{k} - {r}_{1}}{λ}} \qquad [ equation 2 ]$$

where N is the number of ESL radios (e.g., ESL 1 510a, ESL 2 510b, ESL 3 510c), Wₖ are the weights for the ESL radios (e.g., ESL 1 510a, ESL 2 510b, ESL 3 510c), Pₖ are the known positions (e.g., ground truth locations) for the ESL radios (e.g., ESL 1 510a, ESL 2 510b, ESL 3 510c), and λis a factor that determines a “priority level” for how the RSSI measurements are ranked and translated into weights. N is a subset of M. Both N and λ may be empirical terms, which may be preset to some desired value.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

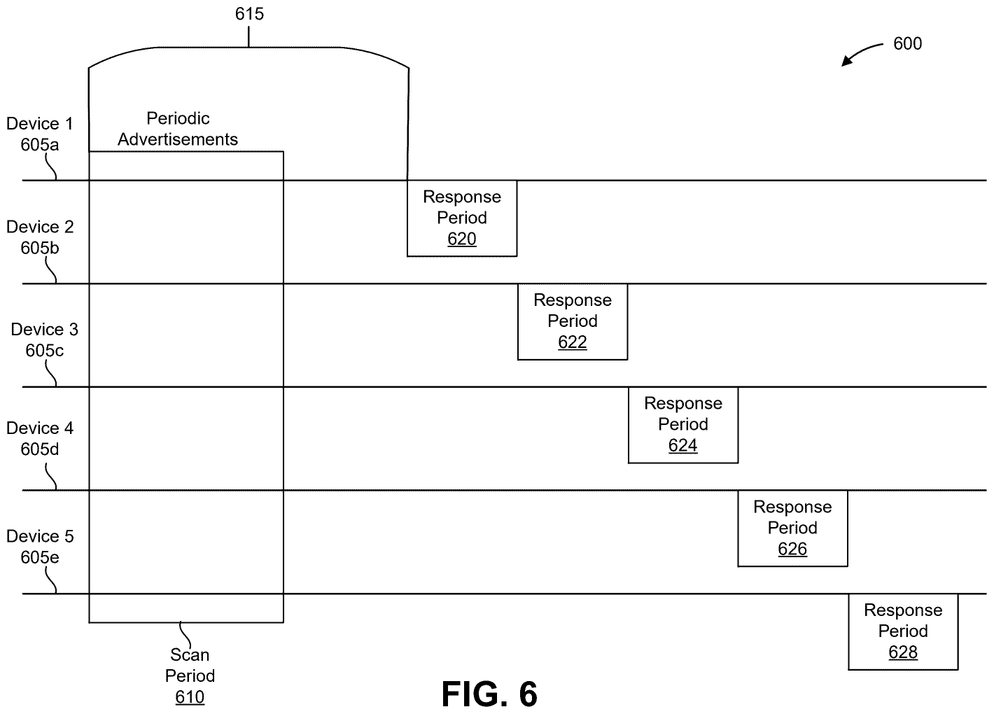

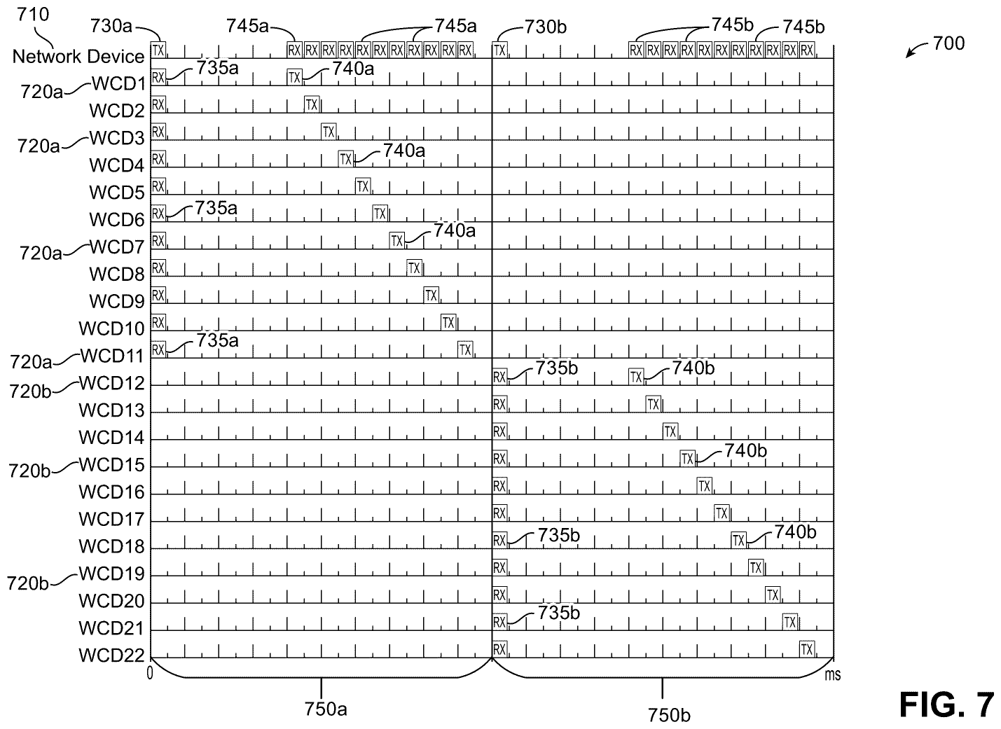

FIGS. 6 and 7 show signaling diagrams illustrating examples of PAwR in an ESL system. In particular, the signaling diagram of FIG. 6 shows an example PAwR for a group of wireless network devices (e.g., device 1 605a, device 2 605b, device 3 605c, device 4 605d, and device 5 605c), and the signaling diagram of FIG. 7 shows an example PAwR for two groups of wireless network devices 720a, 720b (e.g., a first group including ESL 1 to ESL 11, and a second group including ESL 12 to ESL 22). Specifically, FIG. 6 is a signal timing diagram illustrating a portion of a communication between an access point (e.g., access point 110) and wireless communication devices 120 (e.g., ESLs). With reference to FIG. 1, the signal sequence illustrated in FIG. 6 may be implemented by one or more of the communication connections, access points 110, and/or wireless communication devices 120 of FIG. 1.

The devices (e.g., device 1 605a, device 2 605b, device 3 605c, device 4 605d, and device 5 605c) of FIG. 6 may be selected from wireless communication devices 120 of FIG. 1, and may each receive a periodic advertisement (PA) in a scan period 610. The scan period 610 may occur in regularly scheduled intervals and may be repeated periodically such that the devices (e.g., device 1 605a, device 2 605b, device 3 605c, device 4 605d, and device 5 605c) can awaken to scan for messages during this repeated scan period 610. An access point (e.g., access point 110 of FIG. 1) may provide periodic advertisements (PAs) via broadcast or multi-cast to the devices (e.g., device 1 605a, device 2 605b, device 3 605c, device 4 605d, and device 5 605c) in the scan period 610. For an access point (e.g., access point 110 of FIG. 1), the scan period 610 can be its primary transmission period. In some cases, the scan period 610 may not be a fixed time because the access point (e.g., access point 110 of FIG. 1) may send different lengths of data from the start of the scan period 610.

The transmission may include multiple advertisements in a train. One or more portions of the advertisements may be directed to one or more of the devices (e.g., device 1 605a, device 2 605b, device 3 605c, device 4 605d, and device 5 605c). The devices (e.g., device 1 605a, device 2 605b, device 3 605c, device 4 605d, and device 5 605c) may decode or filter the messages intended for each specific device and transmitted during the period when all devices are receiving. In this way, the devices (e.g., device 1 605a, device 2 605b, device 3 605c, device 4 605d, and device 5 605c) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 605a, device 2 605b, device 3 605c, device 4 605d, and device 5 605c).

As illustrated, the devices (e.g., device 1 605a, device 2 605b, device 3 605c, device 4 605d, and device 5 605e) are each assigned a response period 620, 622, 624, 626, 628 in the time after the scan period 610. The response periods 620, 622, 624, 626, 628 for the ESL transmissions occur in a time division multiple access (TDMA) manner. In some cases, the assignment of the response period to a particular device may not be permanent. In some aspects, the assignment may be inferred from a payload of a synchronization message. The first response period 620 may begin following an idle time 615 after the scan period 610, with the idle period being long enough to provide the transmitter device an opportunity to do other Bluetooth related activities. The assigned response periods may also be limited to or designate a particular frequency of the channels on which to respond. For example, in FIG. 6, device 1 605a is assigned response period 620, device 2 605b is assigned response period 622, device 3 605c is assigned response period 624, device 4 605d is assigned response period 626, and device 5 605e is assigned response period 628. The access point (e.g., access point 110 of FIG. 1) may store attributes of the devices (e.g., device 1 605a, device 2 605b, device 3 605c, device 4 605d, and device 5 605c), including whether a device is able to transmit or respond. The PA signaling followed by responses can be referred to as periodic advertisement with multiple responses (PAwMR).

For example, device 3 605c (e.g., wireless communication device 120 of FIG. 1) may be an ESL and may receive a price update in a PA from the access point (e.g., access point 110 of FIG. 1) in scan period 610. The PA received at device 3 605c may include a designated start time for the response period 624 or may include a schedule of response start times for devices including device 3 605c. The response by device 3 605c to the access point (e.g., access point 110 of FIG. 1) may include an acknowledgement, a status code, and/or other information such as battery life, received signal strength, and/or an error notification. The response by device 3 605c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 605a, device 2 605b, device 3 605c, device 4 605d, and device 5 605c) may use channels of the Bluetooth protocol.

A device (e.g., device 5 605e) that has been assigned a response period may not respond and may determine that it has nothing to signal. In other words, the devices (e.g., device 1 605a, device 2 605b, device 3 605c, device 4 605d, and device 5 605e) may determine what response, if any, is required and may or may not respond to a request sent from the access point (e.g., access point 110 of FIG. 1). The response periods 620, 622, 624, 626, 628 may be assigned based on a request for such a period in an open transmission time, the request being sent to the access point (e.g., access point 110 of FIG. 1). The response periods 620, 622, 624, 626, 628 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 7 shows an example PAwR for two groups of wireless network devices 720a, 720b (e.g., a first group including ESL 1 to ESL 11, and a second group including ESL 12 to ESL 22). In particular, FIG. 7 is a signaling diagram illustrating an example of communication transmissions 700 between a network device 710 (e.g., a central device, which may be an access point) and two groups of wireless communication devices 720a, 720b (e.g., peripheral devices, which may be ESLs). With reference to FIG. 1, the signal sequence illustrated in FIG. 7 may be implemented by one or more of the communication connections, access points 110, and/or wireless communication devices 120 of FIG. 1.

In FIG. 7, the signaling diagram is shown in the form of a graph (e.g., a time grid, which may be predetermined) with an x-axis denoting time in milliseconds (ms) and a y-axis denoting specific wireless communication devices 720a, 720b (e.g., ESL 1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 7 denotes time starting from zero (0) ms. The time can be divided into two subframes 750a, 750b. As such, the two subframes 750a, 750b may include a first subframe 750a and a second subframe 750b. In one or more examples, there may be more or less than two subframes 750a, 750b as is shown in FIG. 7, and/or each subframe 750a, 750b may be longer or shorter than as shown in FIG. 7.

In one or more examples, the wireless communication devices 720a, 720b (e.g., peripheral devices) may be assigned (e.g., by the network device 710 and/or by a network entity, such as a management entity) to different groups (e.g., two groups) of wireless communication devices 720a, 720b. For example, wireless communication devices 720a (e.g., ESL 1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 720b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 7, during operation for PAwR, at time 0 ms for the first subframe 750a of time, the network device 710 (e.g., a central, such as an AP) may transmit 730a to a first group (e.g., group 1) of wireless communication devices 720a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 710 and the wireless communication devices 720a, 720b. As noted previously, a synchronization message can include one or more commands. For instance, a command can include an operational code (OpCode) and parameters associated with the command. At time 0 ms, the first group of wireless communication devices 720a (e.g., ESL 1, ESL 2, ESL 3, ESL 4, ESL 5, ESL 6, ESL 7, ESL 8, ESL 9, ESL 10, and ESL 11) can receive 735a the PA containing the synchronization message over the synchronized channel.

In one or more examples, the network device 710 may be configured to transmit PAs at a specified time interval (e.g., a subframe of time), such as is shown in FIG. 7. In one or more examples, the specified time interval (e.g., a subframe) may be shorter or longer than the as is shown in FIG. 7. The wireless communication devices 720a, 720b may respond to a PA by using their specific respective response slot in time.

In one or more examples, the synchronization message transmitted 730a to the first group (e.g., group 1) of wireless communication devices 720a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 720a (e.g., ESL 1, ESL 2, ESL 3, ESL 4, ESL 5, ESL 6, ESL 7, ESL 8, ESL 9, ESL 10, and/or ESL 11) in the first group to use to transmit 740a a response to the network device 710. If a wireless communication device 520a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 720a (e.g., ESL 1, ESL 2, ESL 3, ESL 4, ESL 5, ESL 6, ESL 7, ESL 8, ESL 9, ESL 10, and ESL 11) can respond (e.g., transmit 740a) in its respective response slot, as indicated within the synchronization message. For example, the synchronization message may indicate a specific sequence for one or more of the wireless communication devices 720a (e.g., ESL 1, ESL 2, ESL 3, ESL 4, ESL 5, ESL 6, ESL 7, ESL 8, ESL 9, ESL 10, and/or ESL 11) to respond (e.g., transmit 740a) in time (e.g., responding after 5 ms has elapsed after the start of the subframe 750a at response slots as shown in FIG. 7).

After the wireless communication devices 720a (e.g., ESL 1, ESL 2, ESL 3, ESL 4, ESL 5, ESL 6, ESL 7, ESL 8, ESL 9, ESL 10, and ESL 11) have received 735a the PA containing the synchronization message from the network device 710, according to the sequence specified within the synchronization message, the one or more wireless communication devices 720a (e.g., ESL 1, ESL 2, ESL 3, ESL 4, ESL 5, ESL 6, ESL 7, ESL 8, ESL 9, ESL 10, and/or ESL 11) can transmit 740a their responses within their respective response slots. After the one or more wireless communication devices 720a (e.g., ESL 1, ESL 2, ESL 3, ESL 4, ESL 5, ESL 6, ESL 7, ESL 8, ESL 9, ESL 10, and/or ESL 11) have transmitted 740a their responses in their respective response time slots, the network device 5710 can receive 745a their transmitted responses at those specific response slot times.

During operation for PAwR, for the second subframe 750b of time, the network device 710 may transmit 730b to a second group (e.g., group 2) of wireless communication devices 720b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 710 and the wireless communication devices 720a, 720b. In addition, at the start of the second subframe 750b, the second group of wireless communication devices 720b (e.g., ESL 12, ESL 13, ESL 14, ESL 15, ESL 16, ESL 17, ESL 18, ESL 19, ESL 20, ESL 21, and ESL 22) can receive 735b the PA containing the synchronization message over the synchronized channel.

The synchronization message transmitted 730b to the second group (e.g., group 2) of wireless communication devices 720b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 720b (e.g., ESL 12, ESL 13, ESL 14, ESL 15, ESL 16, ESL 17, ESL 18, ESL 19, ESL 20, ESL 21, and/or ESL 22) in the second group to use to transmit 740b a response to the network device 710. If a wireless communication device 720b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 720b (e.g., ESL 12, ESL 13, ESL 14, ESL 15, ESL 16, ESL 17, ESL 18, ESL 19, ESL 20, ESL 21, and ESL 22) can respond (e.g., transmit 740b) in its respective response slot, as indicated within the synchronization message. For example, the synchronization message may indicate a specific sequence for one or more of the wireless communication devices 720b (e.g., ESL 12, ESL 13, ESL 14, ESL 15, ESL 16, ESL 17, ESL 18, ESL 19, ESL 20, ESL 21, and/or ESL 22) to respond (e.g., transmit 740b) in time (e.g., responding after 5 ms has elapsed after the start of the subframe at response slots as shown in FIG. 7).

After the wireless communication devices 720b (e.g., ESL 12, ESL 13, ESL 14, ESL 15, ESL 16, ESL 17, ESL 18, ESL 19, ESL 20, ESL 21, and ESL 22) have received 735b the PA containing the synchronization message from the network device 710, according to the sequence specified within the synchronization message, the one or more wireless communication devices 720b (e.g., ESL 12, ESL 13, ESL 14, ESL 15, ESL 16, ESL 17, ESL 18, ESL 19, ESL 20, ESL 21, and/or ESL 22) may transmit 740b their responses within their respective response slots. After the one or more wireless communication devices 720b (e.g., ESL 12, ESL 13, ESL 14, ESL 15, ESL 16, ESL 17, ESL 18, ESL 19, ESL 20, ESL 21, and/or ESL 22) have transmitted 740b their responses in their respective response time slots, the network device 710 can receive 745b their transmitted responses at those specific response slot times. The PAwR may continue similarly for subsequent subframes of time.

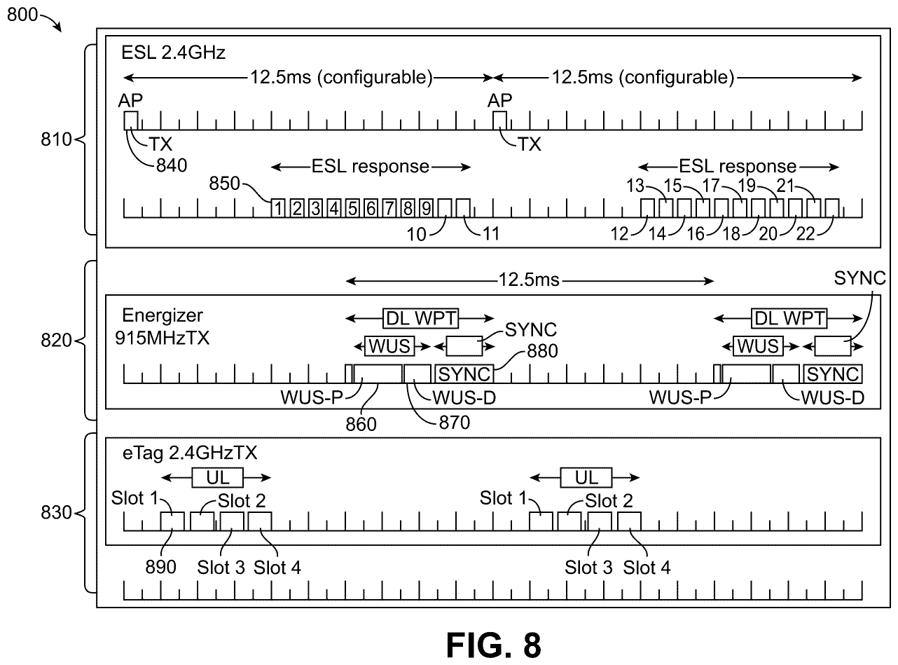

FIG. 8 shows examples of scheduling as per the Bluetooth specification as well as per custom energizing device (energizer)/eTag scheduling. In particular, FIG. 8 is a signaling diagram illustrating examples 800 of communication transmissions 810, 820, 830. Communication transmissions 810 shows scheduling (e.g., for communications between a network device in the form of an access point and ESLs equipped with radios) per the Bluetooth specification, communication transmissions 820 shows custom scheduling for an energizing device, and communication transmissions 820 shows custom scheduling for ambient IOT devices (e.g., eTags).

For the communications 810 of FIG. 8, an access point (AP) can transmit (Tx) an AP beacon 840 (e.g., including an AP_SYNC) once every periodic advertisement interval of 1.6 seconds(s). There may be a total of 128 subevent intervals, each 12.5 milliseconds (ms) long to address the ESLs. The ESLs may be grouped within in 128 groups. An ESL group can include eleven ESLs, which may transmit within a 12.5 ms subframe. There may be a maximum of 128 groups being managed by a single access point, for a total of 1408 ESLs, which may transmit within a 1.6 s frame.

In one or more examples, the AP beacon 840 can include control information indicating when the ESLs should wake up to listen, and when each specific ESL should transmit a response to the access point. The ESLs may be synchronized with the access point. Each ESL can wake up once every 1.6 s to listen for the AP beacon 840 in the subevent matching its own group ID (from 0 to 127). The ESLs can send responses within the response slots 850 (e.g., eleven response slots) assigned to the eleven different ESLs. This signaling pattern can repeat over a certain period of time, until the access point receives responses from all of the ESLs.

For the communications 830, the ambient IOT devices (e.g., eTags) may randomly select one of the four time slots 890, which occur in time (e.g., over a duration of 3.75 ms) between the AP beacon 840 and the response slots 850, to transmit an UL beacon. Each time slot may be larger than the duration of the UL beacon to account for the possibility of poor time synchronization. These time slots repeat every subframe (e.g., of 12.5 ms).

For the communications 820, energizing devices can transmit a DL signal (e.g., every subframe) that may be an energizing signal that energizes ambient IOT devices (e.g., eTags). The DL signal can include a wakeup signal (WUS) and a synchronization waveform (SYNC) 880. The WUS can include a wakeup signal-packet (WUS-P) 860 and wakeup signal-data (WUS-D) 870. The WUS-D 870 can include control information indicating the four time slots 890 that the ambient IOT devices (e.g., eTags) may choose from to transmit an UL beacon to the ESLs. The control information may be in the form of a bitmap, which can be used to relay the control information to the ambient IOT devices (e.g., eTags). The synchronization waveform (SYNC) 880 can be used by the ambient IOT devices (e.g., eTags) to determine the start time and end time of each of the four time slots 890.

In one or more aspects, the way that the ambient IOT devices (e.g., eTags) get charged up can be dependent upon the signal strength of the energizing signal. As such, if the energizing waveform is very strong, the ambient IOT devices (e.g., eTags) can get charged up pretty quickly. However, if the energizing waveform is not strong, then the ambient IOT devices (e.g., eTags) might need multiple instances of waveform reception before the ambient IOT devices (e.g., eTags) can finally charge up to a sufficient amount of charge to be able to transmit.

As such, there can be some asymmetry in how the ambient IOT devices (e.g., eTags) are getting charged up. For example, there may be one ambient IOT device (e.g., eTag), which receives a strong signal strength and, as such, that ambient IOT device (e.g., eTag) would keep transmitting beacons constantly. Whereas, there may be another ambient IOT device (e.g., eTag) located nearby, which may be blocked by some obstacle, such that the ambient IOT device (e.g., eTag) receives a weak signal strength and, as such, this ambient IOT device (e.g., eTag) is not able to transmit beacons as often.

To equalize the transmissions amongst the ambient IOT devices (e.g., eTags), a delay in transmissions may be employed for some of the ambient IOT devices (e.g., eTags). A “Q rule” may be used to determine any delay (e.g., a back off) in transmissions for an ambient IOT device (e.g., eTag).

In one or more examples, he WUS-P 860 may be used for synchronization and received power level estimation. The WUS-P 860 can include 3 bits, which may denote the value of Q. A random number M may be chosen between zero (0) and Q, such that 0≤M<Q. When M is equal to zero (0), an ambient IOT device (e.g., eTag) can transmit immediately (with no delay) after having a sufficient amount of charge for transmissions. However, if M is greater than zero (0), the ambient IOT device (e.g., eTag) can only transmit after a delay of M number of subframes. Then, after the ambient IOT device (e.g., eTag) transmits the beacon, the ambient IOT device (e.g., eTag) can only transmit after a delay of N number of subframes.

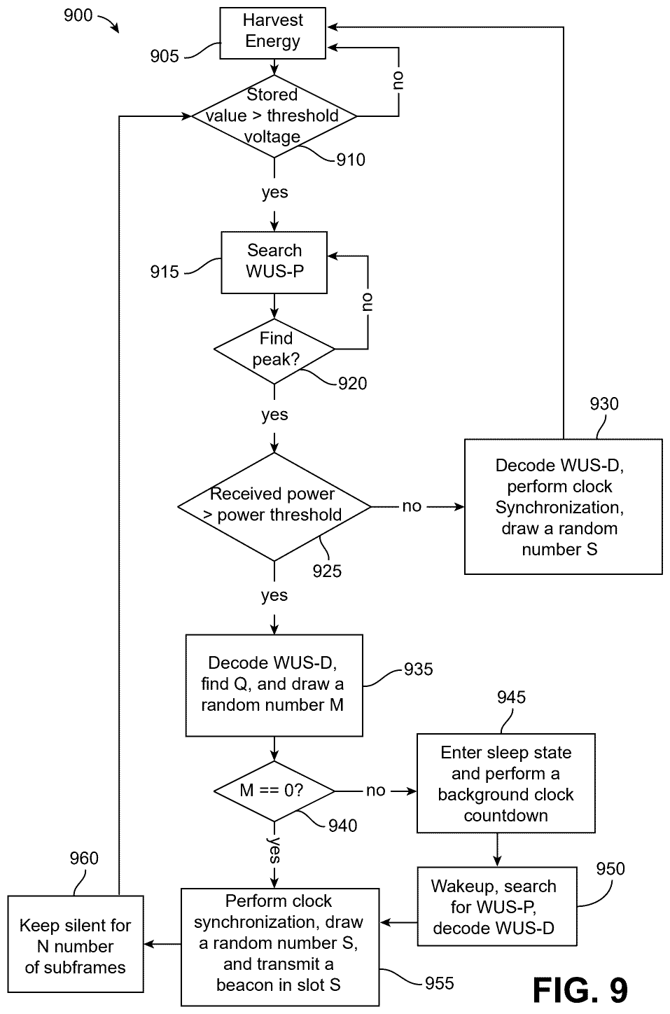

FIG. 9 is a flow diagram illustrating an example of a process 900 for uplink scheduling for ambient IOT devices. FIG. 9 provides an illustrative example of employing the Q rule described above. During operation of the process 900, at block 905, a computing device (e.g., an ambient IOT device, such as an eTag) can harvest energy from an energizing signal transmitted from an energizing device. At decision block 910, the computing device can determine whether its stored charge is greater than or equal to a threshold voltage (e.g., 0.8 volts, 0.85 volts, 0.9 volts, or other threshold voltage). If the computing device determines that its stored charge is greater than the threshold voltage, at block 915, the computing device can search for the WUS-P within the energizing signal.

At decision block 920, the computing device can then determine if the computing device can determine or find a peak within the WUS-P. If the computing device cannot find a peak, the process 900 can proceed back to block 915. However, if the computing device can find the peak, at decision block 925, the computing device can determine if the received power of the energizing signal is greater than a received power threshold. If the computing device determines that the received power is not greater than the received power threshold, at block 930, the computing device can decode the WUS-D, perform a clock synchronization, draw a random number S (e.g., a random number between 1 and 4, such that 1≤S≤4). The computing device can transmit a beacon (transmit packet) in slot S. The process 900 then proceeds back to block 905.

However, if the computing device determines that the received power is not greater than the received power threshold, at block 935, the computing device can decode the WUS-D, find Q, and draw a random number M between zero and Q such that 0≤M<Q. At decision block 940, the computing device can determine whether M is equal to zero. If the computing device determines that M is not equal to zero, at block 945, the computing device can go back to sleep (e.g., enter a sleep state) and perform a background clock countdown (e.g., a background clock countdown of M number of subframes). At block 950, the computing device can wake up (after M number of subframes), search for the WUS-P, and decode the WUS-P. The process 900 can then proceed to block 955.

However, if the computing device determines that M is equal to zero, at block 955, the computing device can perform a clock synchronization, draw a random number S (e.g., a random number between 1 and 4 such that 1≤S≤4), and transmit a beacon (e.g., a transmit packet) in slot S. At block 960, the computing device can keep silent (e.g., not perform any transmissions) for N number of subframes. In some cases, the N number of subframes can be determined by Q. The process 900 can then proceed back to decision block 910.

In one or more aspects, another way to equalize the transmissions amongst the ambient IOT devices (e.g., eTags) is to modify (adapt) the energizing power of subsequent energizing signals transmitted by the energizing devices. For an example scenario, a certain number of energizing devices may transmit energizing signals over an area containing a certain number of ambient IOT devices (e.g., eTags). Meanwhile, the ESL radios within the area can operate in receive mode with a certain pattern or duty cycle. In such an example, an ambient IOT device (e.g., eTag) may embed (within its beacon) a quality metric, which can be used by a network entity (e.g., an edge server) to determine any modification needed for any subsequent energizing signals. The network entity (e.g., edge server) can then command one or more of the energizing devices to modify subsequent energizing signals accordingly.

In some aspects, the quality metric may include, may be associated with, or may be determined based on a current amount of charge being held (remaining) within the ambient IOT device (e.g., eTag) after the ambient IOT device (e.g., eTag) performs a transmission of a beacon. Additionally or alternatively, in some examples, the quality metric may include, may be associated with, or may be determined based on the number of energizing sources that the ambient IOT device (e.g., eTag) is receiving energizing signals from. Additionally or alternatively, in some cases, the quality metric may include, may be associated with, or may be determined based on the signal strengths (e.g., RSSIs) of the energizing signals that the ambient IOT device (e.g., eTag) is receiving from the energizing devices.

In some examples, the quality metric may include an indicator (e.g., of a “0” or a “1) to indicate whether the energizing devices are energizing devices that are within the network (e.g., within the 900 MHz band) of the ambient IOT device (e.g., eTag) such that the energizing devices are under the control of a network entity (e.g., edge server) managing the network. For example, an indicator of “0” can indicate that an energizing device is not within the network of the ambient IOT device (e.g., eTag). An indicator of “1” can indicate that the energizing device is within the network of the ambient IOT device (e.g., eTag).

In one or more examples, after a certain period of time T, N number of ambient IOT devices (e.g., eTags) may be able to transmit beacons, which may be received by the ESL radios within the area. The ESL radios may then relay the beacon payloads (e.g., information within the received beacons that includes the quality metrics) to the network entity (e.g., an edge server). The network entity may calculate (e.g., using a water-filling algorithm), based on the beacon payloads (e.g., including the quality metrics), transmit power for subsequent energizing signals such as to reduce the UL interference by triggering ambient IOT device (e.g., eTag) transmissions sequentially.

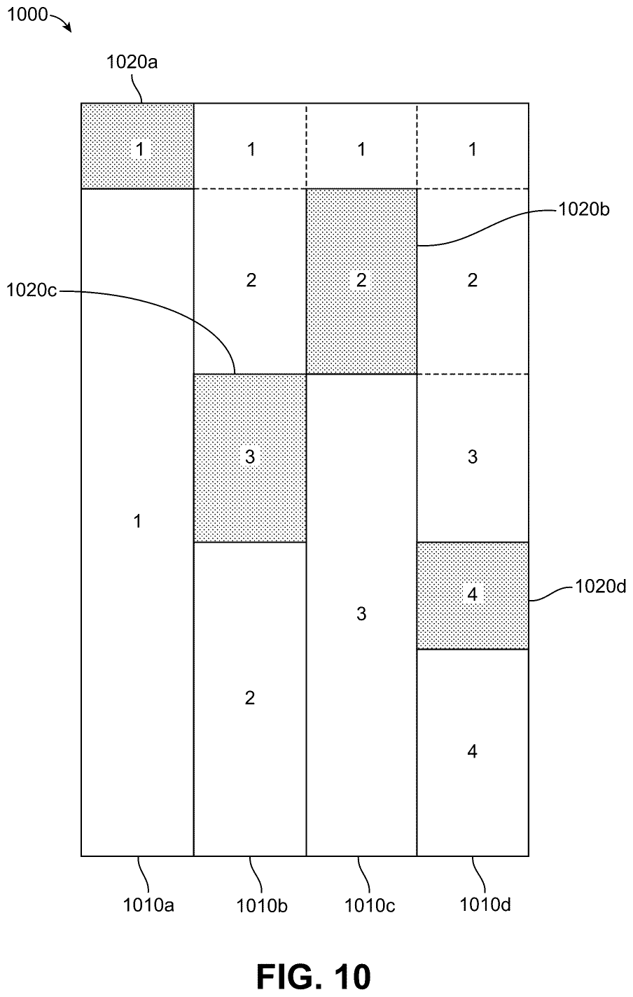

FIG. 10 is a diagram 1000 illustrating an example of triggering of sequential transmissions by ambient IOT devices (e.g., eTags). FIG. 10 provides an illustrative example of the water-filling algorithm described herein. For example, according to the diagram 1000, selectively energizing of ambient IOT devices (e.g., eTag 1, eTag 2, eTag 3, eTag 4) can be performed. In FIG. 10, current charges 1010a, 1010b, 1010c, 1010d stored within the ambient IOT devices (e.g., eTag 1, eTag 2, eTag 3, eTag 4) are shown. For example, the current charge 1010a can be stored within a first ambient IOT device (e.g., eTag 1), the current charge 1010b can be stored within a second ambient IOT device (e.g., eTag 2), the current charge 1010c can be stored within a third ambient IOT device (e.g., eTag 3), and the current charge 1010d can be stored within a fourth ambient IOT device (e.g., eTag 4).

Each ambient IOT device (e.g., eTag 1, eTag 2, eTag 3, eTag 4) is able to transmit a beacon when it is fully charged. For example, eTag 1 is able to transmit a beacon after eTag 1 has current charge 1010a and has received a charge 1020a from an energizing signal.

In one or more examples, the ambient IOT devices (e.g., eTag 1, eTag 2, eTag 3, eTag 4) can be selectively charged up such that the ambient IOT devices (e.g., eTag 1, eTag 2, eTag 3, eTag 4) transmit beacons sequentially. The energizing devices may be assigned (e.g., by the network entity, which may be in the form of an edge server) a set of transmit power values to be used sequentially to trigger sequential transmissions by the ambient IOT devices (e.g., eTag 1, eTag 2, eTag 3, eTag 4).

For example, a first energizing signal can be sent to the ambient IOT devices (e.g., eTag 1, eTag 2, eTag 3, eTag 4) such that the ambient IOT devices (e.g., eTag 1, eTag 2, eTag 3, eTag 4) receive the charge 1020a (e.g., filling the “1” boxes). After the first energizing signal is received by the ambient IOT devices (e.g., eTag 1, eTag 2, eTag 3, eTag 4), eTag 1 will be charged up and, as such, will transmit a beacon. A second energizing signal can then be sent to the ambient IOT devices (e.g., eTag 1, eTag 2, eTag 3, eTag 4) such that the ambient IOT devices (e.g., eTag 1, eTag 2, eTag 3, eTag 4) receive the charge 1020b (e.g., filling the “2” boxes). After the second energizing signal is received by the ambient IOT devices (e.g., eTag 1, eTag 2, eTag 3, eTag 4), eTag 3 will be charged up and, as such, will transmit a beacon. A third energizing signal can then be sent to the ambient IOT devices (e.g., eTag 1, eTag 2, eTag 3, eTag 4) such that the ambient IOT devices (e.g., eTag 1, eTag 2, eTag 3, eTag 4) receive the charge 1020c (e.g., filling the “3” boxes). After the third energizing signal is received by the ambient IOT devices (e.g., eTag 1, eTag 2, eTag 3, eTag 4), eTag 2 will be charged up and, as such, will transmit a beacon. A fourth energizing signal can then be sent to the ambient IOT devices (e.g., eTag 1, eTag 2, eTag 3, eTag 4) such that the ambient IOT devices (e.g., eTag 1, eTag 2, eTag 3, eTag 4) receive the charge 1020d (e.g., filling the “3” box). After the fourth energizing signal is received by the ambient IOT devices (e.g., eTag 1, eTag 2, eTag 3, eTag 4), eTag 4 will be charged up and, as such, will transmit a beacon.

In one or more aspects, additional parameters may be utilized for sequential transmissions by the ambient IOT devices (e.g., eTags). For instance, a transmission indicator value (e.g., a Q-value) can indicate when a ambient IOT device (e.g., eTag) is to transmit. In one or more examples, for example when there is only a single ambient IOT device and, thus, not much UL interference would be expected, lower Q-values (e.g., a value of 0, 1, 2, or other value) may be assigned and sent as part of WUS-D in the energizing signals to that ambient IOT device (e.g., eTag).

As previously mentioned, the energizing devices may have the capability of beamforming to direct their energizing signals. As such, the energizing signals may be directionally beamed towards a specific ambient IOT device (e.g., eTag), whose coarse position estimate is known. Beam weights (or steering vectors for analog beamforming) for the beamforming can be provided by the network entity (e.g., edge server) to one or more energizing devices. In one or more examples, multiple energizing devices may transmit energizing signals at the same time over different beams (and towards different eTags).

In one or more examples, the determination of the quality metric, the Q-values, and/or the beamforming weights may be repeatedly performed periodically, where new charge values may be found for the ambient IOT devices (e.g., eTags) and a new configuration (e.g., transmit power, beam pattern, etc.) can be assigned to the energizing devices by the network entity (e.g., edge server).

In one or more examples, a group of ambient IOT devices (e.g., eTags) may be energized jointly for beacon transmissions and, as such, there can be a chance of collisions amongst their transmissions. The Q rule attempts to solve this collision problem by employing a random slot selection for the beacon transmissions (e.g., 1≥S≥4, where S is the slot index selected for the beacon transmissions after the energizing signal is received).

However, in one or more examples, the slot selection may be more deterministic, where the amount of charge stored within the ambient IOT device (e.g., eTag) prior to transmissions may be used to determine the slot for beacon transmissions. For example, for the ambient IOT devices (e.g., eTag 1, eTag 2, eTag 3, eTag 4) as discussed for FIG. 10, based on their stored current charges 1010a, 1010b, 1010c, 1010c, eTag 1 may transmit a beacon within a first slot (e.g., of the time slots 890), eTag 3 may transmit a beacon within a second slot (e.g., of the time slots 890), eTag 2 may transmit a beacon within a third slot (e.g., of the time slots 890), and eTag 4 may transmit a beacon within a fourth slot (e.g., of the time slots 890).

In one or more aspects, the ESL radios may follow a periodic receive pattern for receiving the beacons transmitted from the ambient IOT devices (e.g., eTags), since the ESL radios do not know when to expect transmissions of the beacons. However, in one or more examples, a specific time window can be implicitly imposed on a beacon transmission. The same time window may be utilized for ESL radio reception. In doing so, the ESL radio power consumption can be conserved since the ESL radios do not need operate in receive mode for extended periods of time, and instead can wake up only when a beacon transmission is imminent.

For example, following each of several assigned (e.g., scheduled) energizing device transmissions, a corresponding receive operation period can be imposed on a group of one or more ESL radios. A network entity (e.g., edge server) can indicate to a group of ESL radios to wake up for reception during a specific time window. In one or more examples, the network entity can indicate a start time of a receive operation (e.g., which can be after the corresponding energizing device transmission is complete), an end time of the receive operation (e.g., which can be before the next scheduled energizing device transmission), and a certain periodicity (or duty cycle) for the receive operation between the start time and the end time. In one or more examples, the duty cycle may be, for example, fifty (50) percent (%), where the ESL radios will be awake for reception during 50% of the time between the start time and the end time.

In one or more examples, a length of the time window (e.g., determined by the network entity) may be related to a Q-value broadcasted by an energizing device in the WUS-D. In some examples, the larger the Q-value, the longer the time window; and the smaller the Q-value, the shorter the time window. In some examples, the size of the time window can be related to the number of ambient IOT devices (e.g., eTags) with a threshold amount of charge. The size of the time window needs to be long enough such that the beacons, transmitted by the ambient IOT devices (e.g., eTags) with the threshold amount of charge, can be received by the ESL radios. In one or more examples, the ESL radios can wake up during the time window to receive the beacons from the ambient IOT devices (e.g., eTags). The ESL radios can then relay the beacon payload to the network device (e.g., edge server).

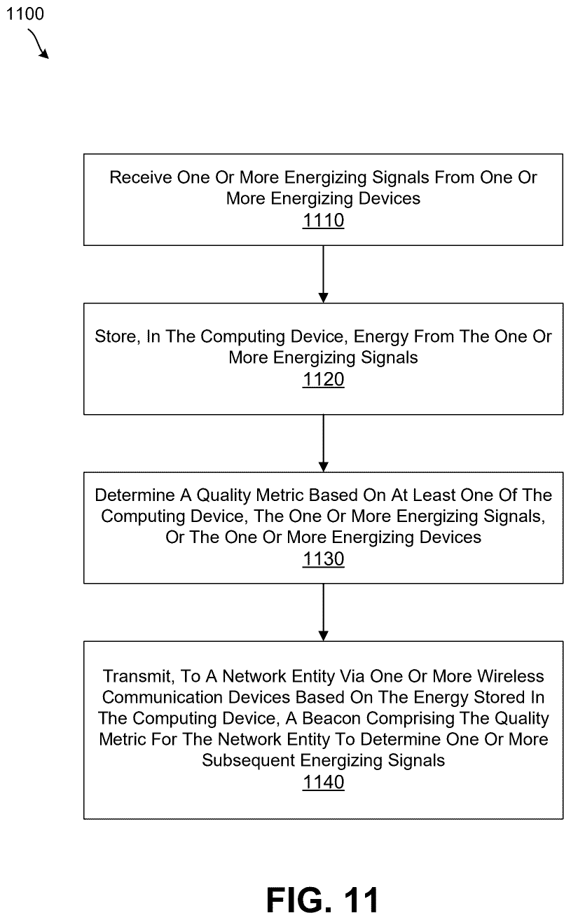

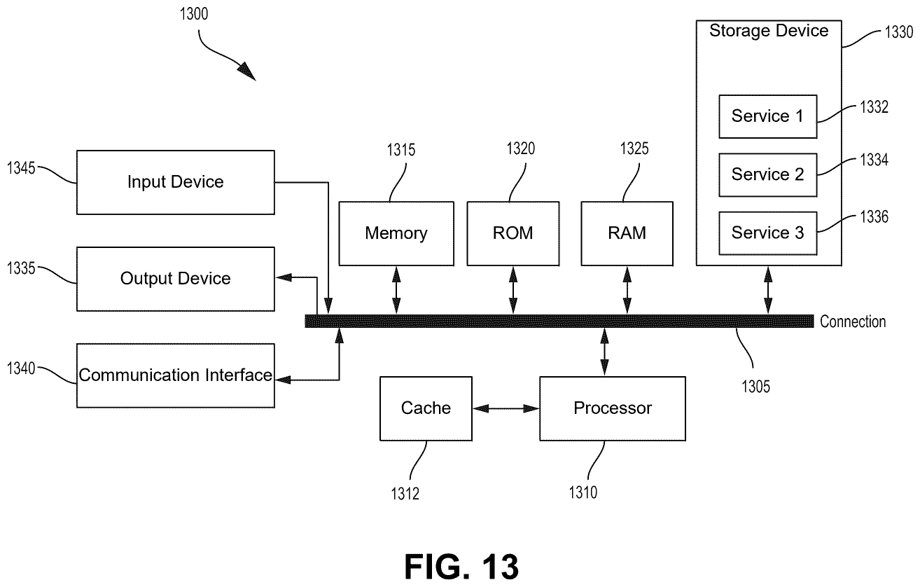

FIG. 11 is a flow chart illustrating an example of a process 1100 for wireless communications at a computing device. The process 1100 can be performed by a computing device (e.g., an ambient IOT device, such as an eTag, for example the RF energy harvesting device 250 of FIG. 2B, the ambient IOT device 310 of FIG. 3, a computing device or computing system 1300 of FIG. 13, or other device) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1100 may be implemented as software components that are executed and run on one or more processors (e.g., processor 1310 of FIG. 13, or other processor(s)). Further, the transmission and reception of signals by the computing device in the process 1100 may be enabled, for example, by one or more antennas and/or one or more transceivers (e.g., wireless transceiver(s)).

At block 1110, the computing device (or component thereof) can receive one or more energizing signals from one or more energizing devices.

At block 1120, the computing device (or component thereof) can store, in the computing device (e.g., in at least one energy storage element, such as the energy storage clement(s) 268 of FIG. 2B), energy from the one or more energizing signals.

At block 1130, the computing device (or component thereof) can determine a quality metric based on the computing device (or component thereof), the one or more energizing signals, the one or more energizing devices, or any combination thereof. In some aspects, as described herein, the quality metric is associated with an amount of charge stored within the computing device (or component thereof, such as the at least one energy storage element), a number of energizing devices of the one or more energizing devices, a signal strength for each energizing signal of the one or more energizing signals, a respective indicator for each energizing device of the one or more energizing devices indicating whether each energizing device is within a network including the computing device, or any combination thereof.

At block 1140, the computing device (or component thereof) can transmit (or output for transmission), to a network entity via one or more wireless communication devices based on the energy stored in the computing device (or component thereof, such as the at least one energy storage clement), a beacon including the quality metric for the network entity to determine one or more subsequent energizing signals. In some aspects, the network entity is a management entity. In some cases, each wireless communication device of the one or more wireless communication devices is an electronic shelf label (ESL) radio or other type of device. In some aspects, the computing device (or component thereof) can transmit the beacon (or output the beacon for transmission) further based on a duration of time elapsing after receiving the one or more energizing signals. In some cases, the duration of time is based on a transmission indicator value (e.g., a Q-value) within the one or more energizing signals. In some examples, the transmission indicator value bounds a random number (e.g., the random number M and/or the random number S described with respect to FIG. 9) for determining a time slot for transmission of the beacon (e.g., as described with respect to FIG. 9).

In some aspects, the computing device (or component thereof) can transmit the beacon (or output the beacon for transmission) further based on an amount of charge stored within the computing device (or component thereof, such as the at least one energy storage element). For instance, as described previously, the amount of charge stored within an ambient IOT device prior to transmissions may be used to determine a slot for beacon transmissions. For example, referring to FIG. 10 as an illustrative example, based on stored current charges 1010a, 1010b, 1010c, 1010c of ambient IOT devices (e.g., eTag 1, eTag 2, eTag 3, eTag 4) of FIG. 10, an eTag 1 (with stored current charge 1010a) may transmit a beacon within a first slot (e.g., of the time slots 890), eTag 3 (with stored current charge 1010c) may transmit a beacon within a second slot (e.g., of the time slots 890), eTag 2 (with stored current charge 1010b) may transmit a beacon within a third slot (e.g., of the time slots 890), and eTag 4 (with stored current charge 1010d) may transmit a beacon within a fourth slot (e.g., of the time slots 890).

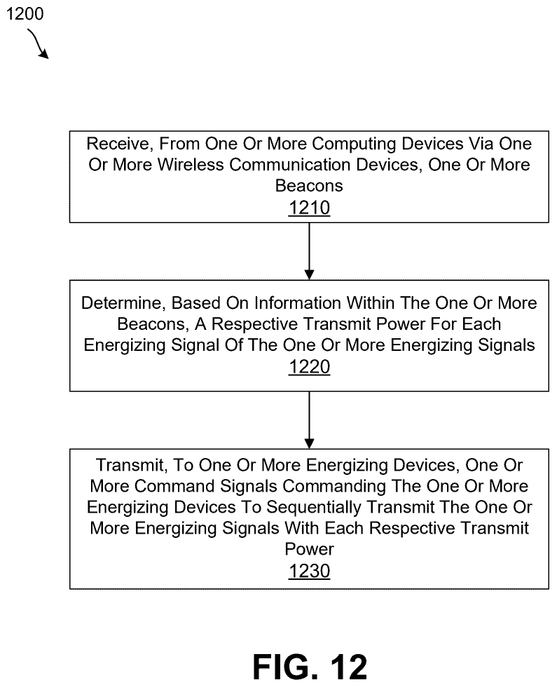

FIG. 12 is a flow chart illustrating an example of a process 1200 for wireless communications at a network entity. The process 1200 can be performed by the network entity (e.g., the network entity 340 of FIG. 3, a computing device or computing system 1300 of FIG. 13, or other network entity) or by a component or system (e.g., a chipset, one or more processors central processing units (CPUs), digital signal processors (DSPs), graphics processing units (GPUs), any combination thereof, and/or other type of processor(s), or other component or system) of the network entity. The network entity can be a management entity (ME), an access point, a server (e.g., an edge server), a base station, or other type of network entity. The operations of the process 1200 may be implemented as software components that are executed and run on one or more processors (e.g., processor 1310 of FIG. 13, or other processor(s)) of the network entity. Further, the transmission and reception of signals by the network entity in the process 1200 may be enabled, for example, by one or more antennas and/or one or more transceivers (e.g., wireless transceiver(s)).

At block 1210, the network entity (or component thereof) can receive, from one or more computing devices via one or more wireless communication devices, one or more beacons. In some aspects, each computing device of the one or more computing devices is an ambient internet of things (IOT) device (e.g., an eTag), such as the RF energy harvesting device 250 of FIG. 2B, the ambient IOT device 310 of FIG. 3, or other ambient IOT device. In some cases, each wireless communication device of the one or more wireless communication devices is an electronic shelf label (ESL) radio. In some aspects, the one or more beacons are received from the one or more wireless communication devices via a network device (e.g., an access point, a base station, or other network device).

At block 1220, the network entity (or component thereof) can determine, based on information within the one or more beacons, a respective transmit power for each energizing signal of one or more energizing signals. In some aspects, the network entity (or component thereof) can determine the respective transmit power for each energizing signal of one or more energizing signals based on a water-filling algorithm (e.g., illustrated with respect to FIG. 10) to trigger sequential transmissions by the one or more computing devices. For instance, as described herein, after a certain period of time T, N number of computing devices (e.g., ambient IOT) devices may transmit beacons, which may be received by the wireless communication devices (e.g., the ESL radios) within the area. The wireless communication devices may then relay payloads of the beacons (e.g., information within the received beacons that includes the quality metrics described herein) to the network entity. The network entity can calculate (e.g., using the water-filling algorithm) transmit power for subsequent energizing signals based on the beacon payloads (e.g., including the quality metrics).

At block 1230, the network entity (or component thereof) can transmit (or output for transmission), to one or more energizing devices, one or more command signals commanding the one or more energizing devices to sequentially transmit the one or more energizing signals with each respective transmit power. As noted previously, such a solution can reduce uplink interference by triggering the computing device (e.g., ambient IOT device) transmissions in an intelligent manner. In some aspects, the one or more command signals include beam weights for beamforming to direct transmission of the one or more energizing signals. In some cases, the one or more command signals include one or more transmission indicator values (e.g., Q-values).

In some aspects, the network entity (or component thereof) can transmit (or output for transmission), to at least one of the one or more wireless communication devices, a start time for receiving one or more subsequent beacons from the one or more computing devices, an end time for receiving the one or more subsequent beacons from the one or more computing devices, and a certain periodicity or duty cycle for receiving between the start time and the end time. For instance, as described herein, following each of several assigned (e.g., scheduled) energizing device transmissions, a corresponding receive operation period can be imposed on a group of the one or more wireless communication devices (e.g., ESL radios). The network entity can indicate to the group of wireless communication devices to wake up for reception during a specific time window. The network entity can indicate the start time of a receive operation (e.g., the start time for receiving the one or more subsequent beacons from the one or more computing devices, which can be after the corresponding energizing device transmission is complete), an end time of the receive operation (e.g., the end time for receiving the one or more subsequent beacons from the one or more computing devices, which can be before the next scheduled energizing device transmission), and the periodicity (or duty cycle) for the receive operation between the start time and the end time. In some examples, the duty cycle may be, for example, fifty (50) percent (%), where the wireless communication devices will be awake for reception during 50% of the time between the start time and the end time.

In some cases, the computing device of process 1100 and process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1100 and process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 and process 1200 are each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for reducing power consumption and UL interference based on feedback from ambient IOT tags. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of”' a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for wireless communications, the apparatus comprising: at least one energy storage element; at least one memory; and at least one processor coupled to the at least one memory and configured to: receive one or more energizing signals from one or more energizing devices; store, in the at least one energy storage element, energy from the one or more energizing signals; determine a quality metric based on at least one of the apparatus, the one or more energizing signals, or the one or more energizing devices; and output, for transmission to a network entity via one or more wireless communication devices based on the energy stored in the apparatus, a beacon comprising the quality metric for the network entity to determine one or more subsequent energizing signals.
Aspect 2. The apparatus of Aspect 1, wherein the quality metric is associated with at least one of an amount of charge stored within the apparatus, a number of energizing devices of the one or more energizing devices, a signal strength for each energizing signal of the one or more energizing signals, or a respective indicator for each energizing device of the one or more energizing devices indicating whether each energizing device is within a network comprising the apparatus.
Aspect 3. The apparatus of any of Aspects 1 or 2, wherein the at least one processor is configured to output the beacon for transmission further based on a duration of time elapsing after receiving the one or more energizing signals.
Aspect 4. The apparatus of Aspect 3, wherein the duration of time is based on a transmission indicator value within the one or more energizing signals.
Aspect 5. The apparatus of Aspect 4, wherein the transmission indicator value bounds a random number for determining a time slot for transmission of the beacon.
Aspect 6. The apparatus of any of Aspects 1 to 5, wherein the at least one processor is configured to output the beacon for transmission further based on an amount of charge stored within the apparatus.
Aspect 7. The apparatus of any of Aspects 1 to 6, wherein the apparatus is an ambient internet of things (IOT) device.
Aspect 8. The apparatus of any of Aspects 1 to 7, wherein each wireless communication device of the one or more wireless communication devices is an electronic shelf label radio.
Aspect 9. The apparatus of any of Aspects 1 to 8, wherein the network entity is a management entity.
Aspect 10. A network entity for wireless communications, the network entity comprising: at least one memory; and at least one processor coupled to the at least one memory and configured to: receive, from one or more computing devices via one or more wireless communication devices, one or more beacons; determine, based on information within the one or more beacons, a respective transmit power for each energizing signal of one or more energizing signals; and output, for transmission to one or more energizing devices, one or more command signals commanding the one or more energizing devices to sequentially transmit the one or more energizing signals with each respective transmit power.
Aspect 11. The network entity of Aspect 10, wherein the at least one processor is configured to determine the respective transmit power for each energizing signal of one or more energizing signals based on a water-filling algorithm to trigger sequential transmissions by the one or more computing devices.
Aspect 12. The network entity of any of Aspects 10 or 11, wherein the one or more command signals comprise beam weights for beamforming to direct transmission of the one or more energizing signals.
Aspect 13. The network entity of any of Aspects 10 to 12, wherein the one or more command signals comprise one or more transmission indicator values.
Aspect 14. The network entity of any of Aspects 10 to 13, the at least one processor is configured to output, for transmission to at least one of the one or more wireless communication devices, a start time for receiving one or more subsequent beacons from the one or more computing devices, an end time for receiving the one or more subsequent beacons from the one or more computing devices, and a certain periodicity or duty cycle for receiving between the start time and the end time.
Aspect 15. The network entity of any of Aspects 10 to 14, wherein the one or more beacons are received from the one or more wireless communication devices via a network device.
Aspect 16. The network entity of Aspect 15, wherein the network device is an access point.
Aspect 17. The network entity of any of Aspects 10 to 16, wherein each computing device of the one or more computing devices is an ambient internet of things (IOT) device.
Aspect 18. The network entity of any of Aspects 10 to 17, wherein the network entity is a management entity.
Aspect 19. The network entity of any of Aspects 10 to 18, wherein each wireless communication device of the one or more wireless communication devices is an electronic shelf label radio.
Aspect 20. A method for wireless communications at a computing device, the method comprising: receiving one or more energizing signals from one or more energizing devices; storing, in the computing device, energy from the one or more energizing signals; determining a quality metric based on at least one of the computing device, the one or more energizing signals, or the one or more energizing devices; and transmitting, to a network entity via one or more wireless communication devices based on the energy stored in the computing device, a beacon comprising the quality metric for the network entity to determine one or more subsequent energizing signals.
Aspect 21. The method of Aspect 20, wherein the quality metric is associated with at least one of an amount of charge stored within the computing device, a number of energizing devices of the one or more energizing devices, a signal strength for each energizing signal of the one or more energizing signals, or a respective indicator for each energizing device of the one or more energizing devices indicating whether each energizing device is within a network comprising the computing device.
Aspect 22. The method of any of Aspects 20 or 21, wherein transmitting the beacon is further based on a duration of time elapsing after receiving the one or more energizing signals.
Aspect 23. The method of Aspect 22, wherein the duration of time is based on a transmission indicator value within the one or more energizing signals.
Aspect 24. The method of Aspect 23, wherein the transmission indicator value bounds a random number for determining a time slot for transmission of the beacon.
Aspect 25. The method of any of Aspects 20 to 24, wherein transmitting the beacon is further based on an amount of charge stored within the computing device.
Aspect 26. The method of any of Aspects 20 to 25, wherein the computing device is an ambient internet of things (IOT) device.
Aspect 27. The method of any of Aspects 20 to 26, wherein each wireless communication device of the one or more wireless communication devices is an electronic shelf label radio.
Aspect 28. The method of any of Aspects 20 to 27, wherein the network entity is a management entity.
Aspect 29. A method for wireless communications at a network entity, the method comprising: receiving, from one or more computing devices via one or more wireless communication devices, one or more beacons; determining, based on information within the one or more beacons, a respective transmit power for each energizing signal of one or more energizing signals; and transmitting, to one or more energizing devices, one or more command signals commanding the one or more energizing devices to sequentially transmit the one or more energizing signals with each respective transmit power.
Aspect 30. The method of Aspect 29, wherein determining the respective transmit power for each energizing signal of one or more energizing signals is based on a water-filling algorithm to trigger sequential transmissions by the one or more computing devices.
Aspect 31. The method of any of Aspects 29 or 30, wherein the one or more command signals comprise beam weights for beamforming to direct transmission of the one or more energizing signals.
Aspect 32. The method of any of Aspects 29 to 31, wherein the one or more command signals comprise one or more transmission indicator values.
Aspect 33. The method of any of Aspects 29 to 32, further comprising transmitting, to at least one of the one or more wireless communication devices, a start time for receiving one or more subsequent beacons from the one or more computing devices, an end time for receiving the one or more subsequent beacons from the one or more computing devices, and a certain periodicity or duty cycle for receiving between the start time and the end time.
Aspect 34. The method of any of Aspects 29 to 33, wherein the one or more beacons are received from the one or more wireless communication devices via a network device.
Aspect 35. The method of Aspect 34, wherein the network device is an access point.
Aspect 36. The method of any of Aspects 29 to 35, wherein each computing device of the one or more computing devices is an ambient internet of things (IOT) device.
Aspect 37. The method of any of Aspects 29 to 36, wherein the network entity is a management entity.
Aspect 38. The method of any of Aspects 29 to 37, wherein each wireless communication device of the one or more wireless communication devices is an electronic shelf label radio.
Aspect 39. A non-transitory computer-readable medium having stored thereon instructions that, when executed by at least one processor, cause the at least one processor to perform operations according to any of Aspects 20 to 28.
Aspect 40. An apparatus for wireless communications, the apparatus including one or more means for performing operations according to any of Aspects 20 to 28.
Aspect 41. A non-transitory computer-readable medium having stored thereon instructions that, when executed by at least one processor, cause the at least one processor to perform operations according to any of Aspects 29 to 38.
Aspect 42. An apparatus for wireless communications, the apparatus including one or more means for performing operations according to any of Aspects 29 to 38.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
at least one energy storage element;
at least one memory; and
at least one processor coupled to the at least one memory and configured to:
receive one or more energizing signals from one or more energizing devices;
store, in the at least one energy storage element, energy from the one or more energizing signals;
determine a quality metric based on at least one of the apparatus, the one or more energizing signals, or the one or more energizing devices; and
output, for transmission to a network entity via one or more wireless communication devices based on the energy stored in the apparatus, a beacon comprising the quality metric for the network entity to determine one or more subsequent energizing signals.

2. The apparatus of claim 1, wherein the quality metric is associated with at least one of an amount of charge stored within the apparatus, a number of energizing devices of the one or more energizing devices, a signal strength for each energizing signal of the one or more energizing signals, or a respective indicator for each energizing device of the one or more energizing devices indicating whether each energizing device is within a network comprising the apparatus.

3. The apparatus of claim 1, wherein the at least one processor is configured to output the beacon for transmission further based on a duration of time elapsing after receiving the one or more energizing signals.

4. The apparatus of claim 3, wherein the duration of time is based on a transmission indicator value within the one or more energizing signals.

5. The apparatus of claim 4, wherein the transmission indicator value bounds a random number for determining a time slot for transmission of the beacon.

6. The apparatus of claim 1, wherein the at least one processor is configured to output the beacon for transmission further based on an amount of charge stored within the apparatus.

7. The apparatus of claim 1, wherein the apparatus is an ambient internet of things (IOT) device.

8. The apparatus of claim 1, wherein each wireless communication device of the one or more wireless communication devices is an electronic shelf label radio.

9. The apparatus of claim 1, wherein the network entity is a management entity.

10. A network entity for wireless communications, the network entity comprising:
at least one memory; and
at least one processor coupled to the at least one memory and configured to:
receive, from one or more computing devices via one or more wireless communication devices, one or more beacons;
determine, based on information within the one or more beacons, a respective transmit power for each energizing signal of one or more energizing signals; and
output, for transmission to one or more energizing devices, one or more command signals commanding the one or more energizing devices to sequentially transmit the one or more energizing signals with each respective transmit power.

11. The network entity of claim 10, wherein the at least one processor is configured to determine the respective transmit power for each energizing signal of one or more energizing signals based on a water-filling algorithm to trigger sequential transmissions by the one or more computing devices.

12. The network entity of claim 10, wherein the one or more command signals comprise beam weights for beamforming to direct transmission of the one or more energizing signals.

13. The network entity of claim 10, wherein the one or more command signals comprise one or more transmission indicator values.

14. The network entity of claim 10, the at least one processor is configured to output, for transmission to at least one of the one or more wireless communication devices, a start time for receiving one or more subsequent beacons from the one or more computing devices, an end time for receiving the one or more subsequent beacons from the one or more computing devices, and a certain periodicity or duty cycle for receiving between the start time and the end time.

15. The network entity of claim 10, wherein the one or more beacons are received from the one or more wireless communication devices via a network device.

16. The network entity of claim 15, wherein the network device is an access point.

17. The network entity of claim 10, wherein each computing device of the one or more computing devices is an ambient internet of things (IOT) device.

18. The network entity of claim 10, wherein the network entity is a management entity.

19. The network entity of claim 10, wherein each wireless communication device of the one or more wireless communication devices is an electronic shelf label radio.

20. A method for wireless communications at a computing device, the method comprising:
receiving one or more energizing signals from one or more energizing devices;
storing, in the computing device, energy from the one or more energizing signals;
determining a quality metric based on at least one of the computing device, the one or more energizing signals, or the one or more energizing devices; and
transmitting. to a network entity via one or more wireless communication devices based on the energy stored in the computing device, a beacon comprising the quality metric for the network entity to determine one or more subsequent energizing signals.
